(19) United States
(12) Patent Application Publication
(10) Pub. No.: US 2025/0062381 A1
(43) Pub. Date: Feb. 20, 2025

(54) RECHARGEABLE AQUEOUS Zn||IS FLOW BATTERY SYSTEM

(71) Applicant: City University of Hong Kong, Hong Kong (HK)

(72) Inventors: Chunyi ZHI, Hong Kong (HK); Zhiquan WEI, Hong Kong (HK); Guojin LIANG, Hong Kong (HK)

(21) Appl. No.: 18/451,132

(22) Filed: Aug. 17, 2023

(51) Int. Cl. H01M 8/18; H01M 4/86; H01M 4/90; H01M 8/0284; H01M 8/08

(52) U.S. Cl. CPC H01M 8/188; H01M 4/8615; H01M 4/9025; H01M 8/0284; H01M 8/08; H01M 4/96; H01M 2250/40

(57) ABSTRACT

The present invention relates to a rechargeable aqueous Zn∥IS flow battery system. The system includes a cathode side comprising an electrode material and a first storage tank providing a catholyte, wherein the catholyte comprises zinc iodide and a soluble starch, forming an electrolyte having aggregated colloidal nanoparticles; an anode side comprising the electrode material and a second storage tank providing an anolyte; and a separator positioned between the cathode and anode. The anolyte and the catholyte flow between the cathode and the anode by a peristaltic pump. The present invention provides a system to further exploit colloidal electrolyte chemistries for the LPPM-based flow battery systems towards power cost-effectiveness and high-temperature large-scale energy storage.

### FIELD OF THE INVENTION

The present invention generally relates to the fields of colloidal chemistry, nanoparticle technology, battery technology and energy storage. More specifically, the present invention provides a rechargeable aqueous zinc∥iodine-starch flow battery.

### BACKGROUND OF THE INVENTION

Energy storage plays a crucial role in enhancing the utilization efficiency of clean and renewable energy sources, such as wind and solar energy. Among various energy storage technologies, flow batteries stand out as a promising option for large-scale storage due to their low-cost and high power characteristics. Aqueous zinc-iodine flow batteries (Zn—I FBs) have garnered attention for their inherent safety, high theoretical specific capacity (268 Ah L⁻¹), and high energy density. Unfortunately, the utilization of Zn—I FBs for large-scale energy storage is hindered by the low operating current density and inferior power density.

At present, the Zn—I FBs face typical bottleneck problems: Firstly, the widespread use of Nafion-membrane systems results in low power density due to limited ionic conductivity and significant overpotentials. Fluorinated Nafion-based membranes are expensive, resulting in a higher overall cost of the batteries. Even though the dense Nafion-based membrane can enhance selectivity for improved coulombic efficiency (CE), it may result in a trade-off with ion conductivity, leading to increased membrane resistance and impaired voltage efficiency (VE) and energy efficiency (EE), especially at high working currents. As a result, Zn—I FBs systems generally suffer from lower power density. Secondly, severe cross-over issues of iodine active materials (Iₓ⁻) lead to capacity loss and low coulombic efficiency in the porous membrane systems.

To overcome these challenges, membrane modifications and/or electrolyte engineering have been identified as potential solutions for Zn—I FBs. Regarding the membrane modifications, the dominant improvement strategies focus on introducing membrane coatings that feature ion-sieving and/or charge-repulsion effects to prevent the cross-over of active species. However, these membrane coating strategies would inevitably face increased inner resistance and resulting enlarged overpotentials. Consequently, the energy efficiency might not be improved by the membrane coating strategy. Moreover, designing new polymeric membranes is hindered by the challenges of achieving precise pore-size modulation, controllable thickness, and specific surface-charged states for the membrane. To address this issue, low-cost polyolefin-based porous membranes (LPPM) have emerged as promising separators to enhance working currents due to their high ionic permeability and low ionic resistance. While low-cost polyolefin-based porous membranes (LPPM) can effectively enhance membrane-based ionic conductivity and improve working currents, they face significant cross-over issues with the iodine catholyte, leading to capacity loss and reduced coulombic efficiency.

Regarding the electrolyte engineering, the development of a large-sized iodine-based catholyte holds great potential for simultaneously maintaining high ionic selectivity and high ionic conductivity suitable for the specific pore-sized porous membrane. However, the electrolyte engineering strategy to achieve this purpose has yet to be developed.

### SUMMARY OF THE INVENTION

Accordingly, the present invention aims to address the challenges associated with aqueous zinc-iodine flow batteries (Zn—I FBs) by employing the electrolyte engineering strategy.

In a first aspect, the present invention provides a rechargeable aqueous Zn∥IS flow battery system. The flow battery system includes a cathode side comprising an electrode material and a first storage tank providing a catholyte; an anode side comprising the electrode material and a second storage tank providing an anolyte; and a separator positioned between the cathode and anode. The anolyte and the catholyte flow between the cathode and the anode by a peristaltic pump. When the rechargeable aqueous Zn∥IS flow battery system is in a charging state, the electrode material on the cathode side absorbs and stores one or more ions from the catholyte, and the electrode material on the anode side absorbs and stores one or more ions from the anolyte.

In accordance with one embodiment, the electrode material includes carbon felt.

In accordance with one embodiment, the carbon felt has a geometric area of 4.0 cm² and a thickness in a range of 1-5 mm.

In accordance with one embodiment, the aggregated colloidal nanoparticles have a mean diameter in a range of 120-140 nm.

In accordance with one embodiment, the anolyte includes zinc chloride.

In accordance with one embodiment, the catholyte is prepared with 2 M ZnI₂ and 0.1 to 2 M of soluble starch dissolved in deionized water, while the anolyte is prepared with 2 M ZnCl₂ in deionized water.

In accordance with one embodiment, the separator includes a porous polypropylene membrane.

In accordance with another embodiment, the rechargeable aqueous Zn∥IS flow battery system further includes a PTFE endplate, a PTFE chamber, a PTFE gasket, a PTFE pad, a PTFE tube, a carbon plate and a Ti foil.

In accordance with one embodiment, the rechargeable aqueous Zn∥IS flow battery system has an overall internal resistance of less than 1 Ωcm².

In accordance with one embodiment, the rechargeable aqueous Zn∥IS flow battery system has a power density of at least 40 mW cm⁻².

In accordance with one embodiment, the rechargeable aqueous Zn∥IS flow battery system exhibits at least 94% coulombic efficiency, at least 75% voltage efficiency, and at least 74% energy efficiency at current densities ranging from 7.5 to 30 mA cm⁻² at room temperature.

In accordance with one embodiment, the rechargeable aqueous Zn∥IS flow battery system exhibits at least 90% coulombic efficiency, at least 75% voltage efficiency, and at least 74% energy efficiency at current densities ranging from 7.5 to 30 mA cm⁻² at a high temperature of 50° C.

In accordance with one embodiment, the rechargeable aqueous Zn∥IS flow battery system delivers a performance in terms of cycling stability for 350 cycles at 30 mA cm⁻².

In accordance with one embodiment, the rechargeable aqueous Zn∥IS flow battery system delivers a performance in terms of cycling stability for 200 cycles at a high volumetric capacity of 32.4 Ah L⁻¹ at a high temperature of 50° C.

In a second aspect, the present invention provides a wind and photovoltaic power generating system including the rechargeable aqueous Zn∥IS flow battery system of the present invention.

The present invention relates to tailoring the sizes of the charged iodine in the catholyte based on the size-sieving effect for the specific pore size of porous membranes. Following the size sieving rule, a high ion selectivity and high ionic conductivity of the IS catholyte were simultaneously achieved. In this case, colloidal IS-based Zn—IS FBs could deliver high reversibility and superior performance, with a coulombic efficiency of at least 95%, a high current density of at least 30 mAh cm⁻², a power density of at least 40 mW cm⁻², and a stable cycling stability for approximately 350 cycles. Furthermore, the scaled-up flow battery module exhibited the potential to be combined with photovoltaic solar packs as integrated renewable energy storage systems.

Compared to the existing technology, the present inventions offer significant advantages, which include:
(a) The starch-based colloidal electrolyte has an extremely simple preparation process, low cost, and minimal environmental pollution;
(b) The starch-based colloidal electrolyte exhibits remarkable high-temperature performance, reaching as high as 50° C.;
(c) The present invention can achieve renewable energy storage integration systems between the scaled-up flow battery modules and photovoltaic solar packs.

(d) The present invention provides high power output due to the utilization of a low-cost membrane, resulting in a significant reduction in the installed cost of the 1-MW flow stack to only 7% of the cost compared to the installed cost of the 1-MW conventional Nafion membrane, which is approximately 14.3 times lower.

### BRIEF DESCRIPTION OF THE DRAWINGS

Embodiments of the present invention are described in more detail hereinafter with reference to the drawings, in which:

FIG. 1(a) shows a schematic illustration of cross-over-free zinc-iodine flow batteries (Zn—I FBs) under room and high-temperature conditions. FIG. 1(b) shows a schematic illustration of cross-over of polyiodide (Iₓ⁻) through the pristine LPPM, resulting in severe cell discharge in conventional Zn—I FBs. FIG. 1(c) shows a schematic illustration of how colloidal chemistry-based electrolytes restrict the cross-over of active materials (Iₓ⁻) due to the size limitation induced by the colloidal aggregation effect;

FIG. 2 shows the chemical and molecular structure of starch;

FIG. 3A shows digital images of blank starch solution (1 M), blank polyiodide (Iₓ⁻) solution (0.01 M), and Iₓ⁻ solution (0.01 M) with starch (1 M). FIG. 3B depicts viscosity, ionic conductivity, and Iₓ⁻ permeability of 2 M ZnI₂ electrolytes with different starch concentrations. FIG. 3C depicts size distribution of the colloidal particles in blank starch solution and starch at 50% SOC, respectively. FIG. 3D depicts Raman spectra of starch/polyiodide complex at different SOC; FIG. 3E depicts the calculated ratio between I₅⁻ and I₃⁻ of blank 2 M ZnI₂ and ZnI₂ with 1 M starch at different SOCs. FIG. 3F shows the evolution of bonding energy of I₃⁻ and I₅⁻ interacting with the soluble starch;

FIG. 4 shows photographs of different concentration of starch in 2 M ZnI₂;

FIG. 5 shows the model of Ionic permeation measurements;

FIG. 6A shows UV-visible spectra of KI₃ under multiple concentrations. FIG. 6B shows Beer's law plot for I₃ multiple concentrations between 0.1 mM to 1 mM;

FIG. 7 shows KI₃ permeate solutions through PP membranes under blank 2 M KI₃ electrolytes, UV-vis of the KI₃ permeate side and permeability of KI₃ through PP membranes;

FIG. 8 shows KIₓ permeate solutions through PP membranes under 2 M KIₓ with 0.1 M starch electrolytes, UV-vis of the KIₓ permeate side and permeability of KIₓ through PP membranes;

FIG. 9 shows KIₓ permeate solutions through PP membranes under 2 M KIₓ with 0.2 M starch electrolytes, UV-vis of the KIₓ permeate side and permeability of KIₓ through PP membranes;

FIG. 10 shows KIₓ permeate solutions through PP membranes under 2 M KIₓ with 0.5 M starch electrolytes, UV-vis of the KIₓ permeate side and permeability of KIₓ through PP membranes;

FIG. 11 shows KIₓ permeate solutions through PP membranes under 2 M KIₓ with 1 M starch electrolytes, UV-vis of the KIₓ permeate side and permeability of KIₓ through PP membranes;

FIG. 12 shows KIₓ permeate solutions through PP membranes under 2 M KIₓ with 2 M starch electrolytes, UV-vis of the KIₓ permeate side and permeability of KIₓ through PP membranes;

FIG. 13 shows KIₓ permeate solutions through PP membranes under 2 M KIₓ with 3 M starch electrolytes, UV-vis of the KIₓ permeate side and permeability of KIₓ through PP membranes;

FIGS. 14(a)-(c) show AFM images of 1 M starch solution;

FIG. 15 depicts particle size distribution of 1 M starch;

FIG. 16 depicts an AFM image of 1 M starch solution interacted with Iₓ⁻ in 50% SOC.

FIG. 17 shows particle size distribution of 1 M starch with Iₓ⁻ in 50% SOC;

FIG. 18 depicts nitrogen adsorption/desorption curves of PP membrane. The inset is pore size distribution;

FIG. 19 depicts I 3d XPS depth profiles of I₃⁻ and I₅⁻ species with/without starch under 50% SOC;

FIG. 20 shows the electrostatic potential (ESP)-mapping of starch molecules;

FIG. 21 shows photographs of the cell components of 2×2 cm² cell for flow cell tests;

FIG. 22A depicts CE, VE and EE of the Zn—IS FBs (2 ml of 2 M ZnI₂ with 1 M starch∥PP membrane∥8 ml of 2 M ZnCl₂, 4 cm² membrane area) under 7.5, 15, 22.5, 30 and 37.5 mA cm². FIG. 22B depicts voltage profiles of the Zn—IS FBs under 7.5, 15, 22.5, 30 and 37.5 mA cm². FIG. 22C depicts the polarization of the Zn—IS FBs using different membranes. FIG. 22D depicts cycling performance of Zn—I FBs system at high power density (30 mA cm²). The insert is the corresponding voltage profile. FIG. 22E depicts cycling performance of Zn—I FBs system with/without starch at high volume capacity (50% SOC. 36 Ah L⁻¹) under a current density of 22.5 mA cm⁻². The insert is the corresponding voltage profile;

FIG. 23 depicts galvanostatic cycling of Zn—IS FBs (2 ml of 2 M ZnI₂ with 1 M starch∥PP membrane∥8 ml of 2 M ZnCl₂, 4 cm² membrane area) under 7.5, 15, 22.5, 30, and 37.5 mA cm² at room temperature;

FIG. 24 depicts voltage profiles of the Zn—I FBs using N117 membrane without starch at different current densities;

FIG. 25 depicts EIS of the Zn—I FBs using different membranes (PP membrane with 1M starch and N117 membrane without starch) under charging to 30 mAh;

FIG. 26A depicts cycling performances of Zn—I FBs system using PP membrane without starch at high volume capacity under 22.5 mA cm⁻². Selected cycles corresponding to (FIG. 26B) region (18 th-23 th) and (FIG. 26C) region (54 th-56 th), where the short-circuit point and cross-over is marked;

FIG. 27A depicts galvanostatic cycling of Zn—I FBs using N117 membrane at high volume capacity. FIG. 27B depicts cycling performances of Zn—I FBs system using PP membrane without starch at high volume capacity (33.5 Ah L⁻¹) under 22.5 mA cm⁻². Selected cycles corresponding to (FIG. 27C) region (41^{th}-44^{th}) and (FIG. 27D) region (106^{th}-144^{th}), where the soft short-circuit, severe short-circuit points and cross-over is marked;

FIG. 28a shows the SEM image of pristine CF in the discharging state at 22.5 mA cm⁻² and 33.5 Ah L⁻¹ after 30 cycles, FIG. 28b shows the SEM image of CF anode using PP membrane without starch in the discharging state at 22.5 mA cm⁻² and 33.5 Ah L⁻¹ after 30 cycles. FIG. 28c shows the SEM image of CF anode using PP membrane with starch in the discharging state at 22.5 mA cm⁻² and 33.5 Ah L⁻¹ after 30 cycles;

FIG. 29 depicts XRD pattern of pristine CF, CF using PP membrane without starch, and CF using PP membrane with starch;

FIG. 30a shows the SEM image of pristine PP membrane in the discharging state at 22.5 mA cm⁻² and 33.5 Ah L⁻¹ after 30 cycles. FIG. 30b shows the SEM image of PP membrane after cycles without starch in the discharging state at 22.5 mA cm⁻² and 33.5 Ah L⁻¹ after 30 cycles. FIG. 30c shows the SEM image of PP membrane after cycles with starch in the discharging state at 22.5 mA cm⁻² and 33.5 Ah L⁻¹ after 30 cycles.

FIG. 31 depicts XRD pattern of pristine PP and PP membrane after cycles with/without starch;

FIG. 32 shows the SEM image of CF anode using N117 membrane without starch in the discharging state at 22.5 mA cm⁻² and 33.5 Ah L⁻¹ after 30 cycles;

FIG. 33a shows the SEM image of pristine N117 on the anode side. FIG. 33b shows the SEM image of N117 membrane without starch on the anode side;

FIG. 34A and FIG. 34B depict XRD pattern of pristine N117 membrane and N117 membrane without starch on the anode side, and CF anode using N117 membrane without starch in the discharging state at 22.5 mA cm⁻² and 33.5 Ah L⁻¹ after 30 cycles;

FIG. 35A depicts CE, VE and EE of the Zn—I FBs under 7.5, 15, 22.5, 30, and 37.5 mA cm² at high temperature (50° C.). FIG. 35B depicts voltage profiles of the Zn—IS FBs under 77.5, 15, 22.5, 30, and 37.5 mA cm². FIG. 35C depicts the polarization of the Zn—IS FBs using PP membranes at high temperature (50° C.). FIG. 35D depicts cycling performances of Zn—IS FBs system at high power density (30 mA cm²) and high temperature (50° C.). The inset is the corresponding voltage profile. FIG. 35E depicts cycling performances of Zn—IS FBs system with/without starch at high volume capacity (35.5 Ah L⁻¹) and high temperature (50° C.) under a current density of 22.5 mA cm⁻². The inset is the corresponding voltage profiles;

FIG. 36 depicts galvanostatic cycling of Zn—IS FBs under different current densities at high temperature (50° C.);

FIG. 37A depicts cycling performances of Zn—I FBs system using PP membrane without starch at high volume capacity. Selected cycles corresponding to

(FIG. 37B) region (6 th-9 th) and

(FIG. 37C) region (21^{th}-24^{th}), where the short-circuit point and cross-over is marked;

FIG. 38 shows photographs of the cell components of 5×5 cm² cell for flow cell tests; and

FIG. 39A shows data of sunlight intensity (top) and charging current density (bottom) from the renewable energy storage demonstration system based on a large-sized Zn—IS FBs for one day.

FIG. 39B depicts discharge voltage profiles of large-sized Zn—IS FBs flow cell after charging one day by solar photovoltaic cells at 20 mAh cm⁻².

FIG. 39C shows solar-powered battery energy storage systems at day and night.

FIG. 39D and FIG. 39E show cost analysis based on a 1MW Zn—I FBs flow stack based on the Nafion 117 membrane and PP with starch additives.

### DETAILED DESCRIPTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variation and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

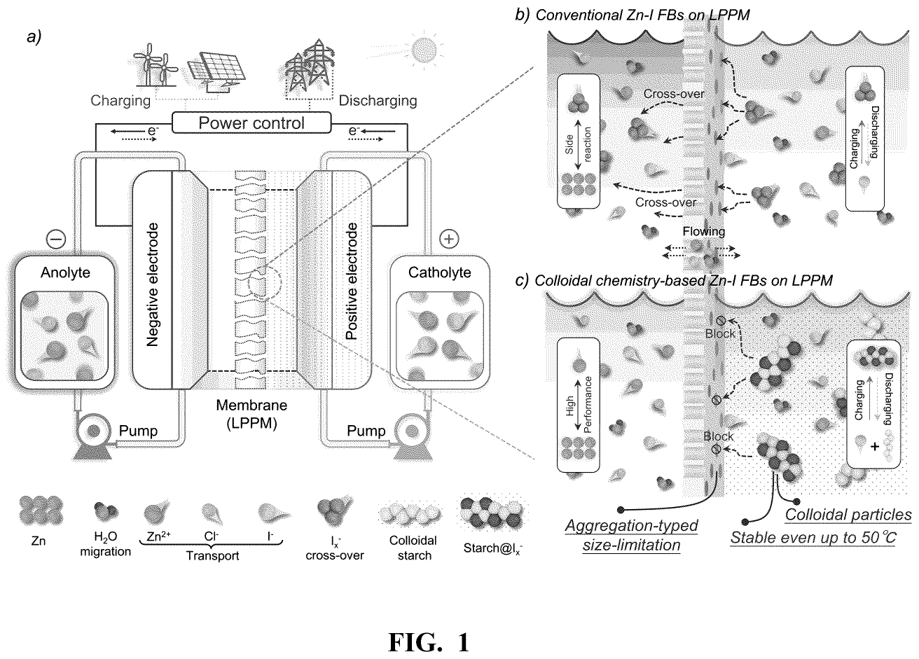

Traditionally, efforts have primarily focused on membrane modifications to enhance the performance of Zn—I FBs. However, such strategies may face challenges related to the high cost and precise synthesis of nanostructured materials with the required sieving sizes and specific loaded charges. The pristine LPPM will inevitably exhibit low selectivity for the active materials, specifically the charged iodine species, resulting in irreversibility at the cathode side, along with severe cross-over and capacity loss, as shown in FIGS. 1(a)-(b). Meanwhile, the notorious cross-over issue of the catholyte may exacerbate, especially when Zn—I FBs are integrated with renewable power energy sources (e.g., solar and wind energy) and operated in outdoor environments with high temperatures.

To address the limitations of pristine LPPMs, a functional coating layer can be introduced, designed to provide ion-sieving limitations and/or charge repulsion effects, effectively preventing the cross-over of redox species. However, implementing such strategies may lead to increased ionic resistance and encounter challenges related to the high cost and precise synthesis of nanostructured materials with specific sieving sizes and designated loaded charges. Based on the principle of the size-sieving effect in the LPPM, there is significant potential to enhance the selectivity of these membranes by regulating the sizes of the active materials, specifically the charged iodine species in the electrolyte.

Accordingly, in a first aspect, the present invention provides a rechargeable aqueous Zn∥IS flow battery system. The flow battery system includes a cathode side comprising an electrode material and a first storage tank providing a catholyte; an anode side comprising the electrode material and a second storage tank providing an anolyte; and a separator positioned between the cathode and anode. The anolyte and the catholyte flow between the cathode and the anode by a peristaltic pump. When the rechargeable aqueous Zn∥IS flow battery system is in a charging state, the electrode material on the cathode side absorbs and stores one or more ions from the catholyte, and the electrode material on the anode side absorbs and stores one or more ions from the anolyte. It presents an extremely simple modification method for improving Zn—I flow battery systems. The starch-containing colloidal chemistry can enhance polyiodide selectivity based on the size-sieving effect, enabling the use of low-cost porous membranes with superior ion conductivity suitable for Zn—I FBs.

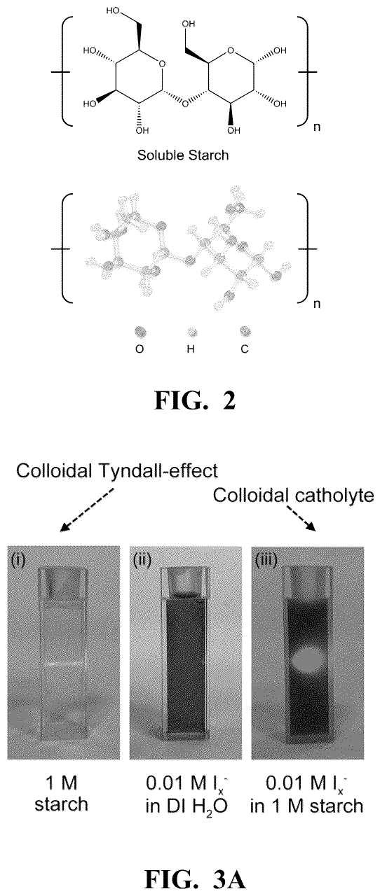

The present invention introduces a novel colloidal chemistry approach for the iodine catholyte of Zn—I FBs by introducing renewable and cost-effective starch into the catholyte. Starch is a long-chain polymer composed of sugar molecules connected through glycosidic linkages, as illustrated in FIG. 2. The soluble amylose starch molecule has a linear polymer structure that can dissolve in water and form hydrogen bonds with water molecules, leading to the formation of a colloidal solution. The interaction between starch and iodine is attributed to the electron-donating properties of hydroxyl functional groups. These hydroxyl groups (—OH) are capable of donating electrons to other atoms through covalent or hydrogen bonds. In an iodine-starch complex, iodine atoms form a complex with the hydroxyl groups of the starch molecule, resulting in a strong chemical interaction between the oxygen atom of the hydroxyl group and the iodine atom, thereby contributing to the stability of the complex.

The IS-based active materials in the catholyte can be regulated into aggregated colloidal nanoparticles, adhering to the size sieving rule. This regulation enables the simultaneous achievement of high ionic selectivity and ionic conductivity of the IS catholyte. Referring to FIG. 1(c), the electrolyte regulation was employed to increase the sizes of the active iodine species, making them larger than the pore size of the applied LPPM, ideally eliminating the cross-over issue of the charged iodine species. The formation of large-sized colloidal iodine-starch (IS) active species possess great potential to avoid the loss of active redox caused by the LPPM.

In one of the embodiments, the catholyte includes zinc iodide (ZnI₂) and a soluble starch, which together form an electrolyte having aggregated colloidal nanoparticles. The anolyte includes zinc chloride.

The catholyte is prepared with 2 M ZnI₂ and 0.1 to 2 M of soluble starch dissolved in deionized water, while the anolyte is prepared with 2 M ZnCl₂ in deionized water. Preferably, the concentration of soluble starch is 1 M.

In one of the embodiments, the electrode material may be carbon felt. The carbon felt has a geometric area of 4.0 cm² and a thickness in a range of 1-5 mm. For example, the carbon felt has a thickness of 1 mm, 2 mm, 3 mm, 4 mm or 5 mm.

In one of the embodiments, the separator may be a porous polypropylene membrane.

In one of the embodiments, the iodine-starch (IS) colloids are configured with an enlarged size based on the colloidal aggregation effect with strong chemisorption. The size-sieving effect effectively inhibits the iodine cross-over, enabling the utilization of porous PP membranes with superior ionic conductivity. The aggregated colloidal nanoparticles have a mean diameter in a range of 120-140 nm. Preferably, the aggregated colloidal nanoparticles have a mean diameter in a range of 134 nm.

In another embodiments, the rechargeable aqueous Zn∥IS flow battery system further includes a PTFE endplate, a PTFE chamber, a PTFE gasket, a PTFE pad, a PTFE tube, a carbon plate and a Ti foil.

In one of the embodiments, the rechargeable aqueous Zn∥IS flow battery system has an overall internal resistance of less than 1 Ωcm². For example, the rechargeable aqueous Zn∥IS flow battery system has an overall internal resistance is 0.91 Ωcm².

In one of the embodiments, the rechargeable aqueous Zn∥IS flow battery system has a power density of at least 40 mW cm⁻².

In one of the embodiments, the rechargeable aqueous Zn∥IS flow battery system exhibits at least 94% coulombic efficiency, at least 75% voltage efficiency, and at least 74% energy efficiency at current densities ranging from 7.5 to 30 mA cm⁻² at room temperature. In another embodiments, the rechargeable aqueous Zn∥IS flow battery system exhibits at least 90% coulombic efficiency, at least 75% voltage efficiency, and at least 74% energy efficiency at current densities ranging from 7.5 to 30 mA cm⁻² at a high temperature of 50° C.

In one of the embodiments, the colloidal IS-based Zn—IS FBs with polypropylene (PP) membranes as LPPM deliver superior performance in terms of cycling stability for 350 cycles at 30 mA cm⁻².

In one of the embodiments, the colloidal IS-based Zn—IS FBs with polypropylene (PP) membranes exhibit superior cycling stability of 200 cycles at a high volumetric capacity of 32.4 Ah L⁻¹ (50% state of charge) even at a high temperature of 50° C.

In one of the embodiments, the installed cost of the 1-MW flow stack can dramatically decrease by 14.3 times compared to the installed cost for Nafion membranes.

In a second aspect, the present invention provides a wind and photovoltaic power generating system including the rechargeable aqueous Zn∥IS flow battery system of the present invention.

The scaled-up flow battery module has been successfully integrated with photovoltaic solar packs, creating renewable energy storage systems. This significant achievement opens up a novel frontier in the development of colloidal electrolyte chemistries for LPPM-based flow battery systems, leading towards low-cost, high-power, and high-temperature flow batteries for large-scale energy storage applications.

The following examples illustrate the present invention and are not intended to limit the same.

### EXAMPLE

### Example 1—Materials and Methods

### Materials

All chemicals were used as received. Zinc iodide (ZnI₂, ≥99.99%), zinc chloride (ZnCl₂, ≥99.99%), starch soluble ((C₆H₁₀O₅)ₙ, ≥99%). potassium iodide (KI, ≥99%), potassium hydroxide (KOH, ≥8%), sulfuric acid (H₂SO₄, 95%-98%), hydrogen peroxide (H₂O₂, 30 wt % in H₂O), iodine (I₂, ≥99%) were received from Sigma-Aldrich. Graphite felt (3.0 mm, carbon≥99%, bulk density 0.12-0.14 g cm⁻²) was received from Yi Deshang Carbon Technology. Nafion membrane (N117, Dupont) was received from Shanghai Hesen Electric. Polypropylene (PP) membrane (Celgard 2325) was received from Suzhou Sinoro Technology. Ti mesh (99.9%, 100 mesh) was obtained from Kangwei Metal. Zn foil (200 μm, 99.99%) was purchased from Chenshuo Metal.

### Characterization of Materials

The crystal structure was studied by X-ray diffraction (XRD, X'Pert Pro MPD, Philips, Holland) using Cu Kα as the radiation source under 40 kV and 40 mA. Morphologies were probed by scanning electron microscopy ((SEM, FEI Quanta 450 FEG SEM). X-ray photoelectron spectroscopy (XPS) spectra were recorded on a photoelectron spectrometer (ESCALAB 250, Thermo Scientific, America), where the binding energy (BE) of the elements was calibrated by the BE of C 1s (284.60 eV). The modulus mapping was measured by atomic force microscope (Bruker, DIMENSION ICON) and conducted in the quantitative nano-mechanics mode (QNM). Raman measurement (Dxr-2xi, Thermo Scientific, America) was performed with in situ homemade cells to observe the O—H stretching peak.

### Density Functional Theory (DFT) Calculation

Electrostatic potential (ESP) mappings were carried out with the Gaussian 09W software package to gain structural information of the abovementioned molecules. Geometrical optimization adopted the B3LYP method with 6-31+G(d,p) basis sets. Based on the optimized structure of molecules, ESP analysis on van der Waals surface was done to deduce the possible soluble starch functional sites using the Multiwfn 3.3.8 software package in the Gaussian 09W software package. The structures of I₃⁻ or I₅⁻, soluble starch, and their complex (soluble starch@I₃⁻ or soluble starch@I₅⁻) were first optimized by using the density functional theory (DFT) at the B3LYP/def2-TZVP level. All geometry optimizations, including the implicit solvent model with SMD were performed using the DFT-D3 method in ORCA. Then, the single-point energies of complexes were done at the same level after the previous optimization, which considering basis set superposition error (BSSE). The harmonic frequency calculations were carried out at the same level of theory to help verify that all structures have no imaginary frequency.

The binding energy of the configuration (Ebind) was calculated by the following equation:

$${E}_{bind} = {E}_{AB} - ( {E}_{A} + {E}_{B} ) , \qquad ( 3 )$$

where E_{A}, E_{B}, and E_{AB} respectively represented the energies of A (I₃⁻ or I₅⁻) and B (soluble starch) and the complex energy, a negative value of Ebind indicated that the process was an exothermic reaction and a high negative value corresponded to a stronger interaction, indicating more heat release and a more stable product.

### Electrochemical Characterization

EIS measurements were carried out on a CHI electrochemical testing unit (760E). The sinusoidal voltage oscillations of 10 mV amplitude at the OCV of the cells were collected before tests. The oscillation frequencies ranged from 1,000 kHz to 100 mHz with three repetitions for every test.

The galvanostatic characterizations of the Zn—I FBs cells were conducted on a battery testing system (LAND, CT2001A) at room temperatures (23-25° C., unless otherwise specified) or reacted in incubator at high temperatures (50° C.). The current densities were set in the range 5 to 50 mA cm⁻², and the cell voltages were set in the range 0.2 V to 1.9 V. The charging process was limited by the constant capacity (30 mAh or 71 mAh) and discharging process was limited by cut-off voltage of 0.1 V. The theoretical capacity was calculated with the catholyte (the iodide part), which was the capacity-limiting side for the full cell.

### Example 2—Preparation of Starch-Containing Colloidal Electrolytes

In one example, the preparation of colloidal iodine-starch in the catholyte of batteries involves the following steps. Firstly, iodine (I₂) was dissolved in water to form an iodine solution. This solution contained charged iodine species (I₃⁻) and uncharged iodine molecules (I₂). Next, the starch molecules formed complexes with the charged iodine species (I₃⁻). Hydrogen bonds were formed between the oxygen atoms in starch and the iodine species, resulting in a tight association between iodine and starch. Due to the complexation between starch and charged iodine species, iodine-starch (IS) colloids were formed. These colloids consisted of large-sized polymer particles.

The colloidal chemistry-based electrolytes can regulate the size of iodine-starch (IS)-based redox active materials as aggregated colloidal nanoparticles in the catholyte, thereby inhibiting the cross-over issue to improve capacity retention.

### Example 3—Characterizations of Starch-Containing Colloidal Electrolytes

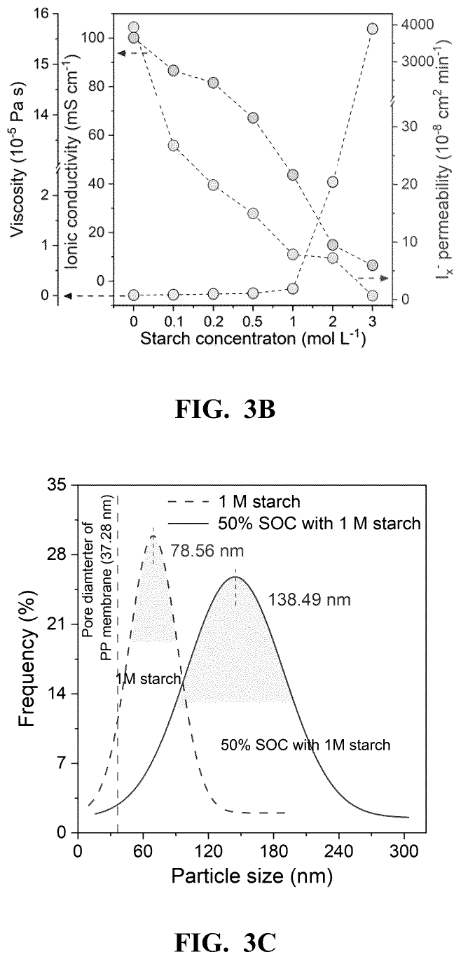

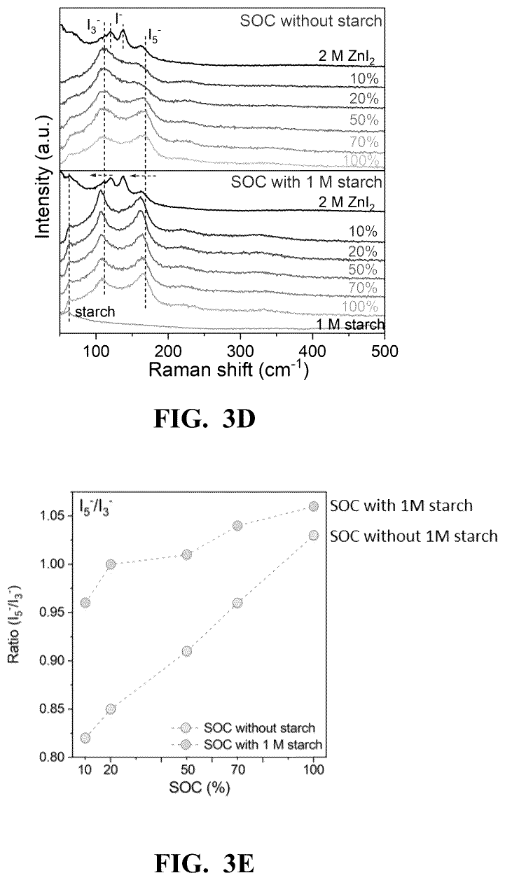

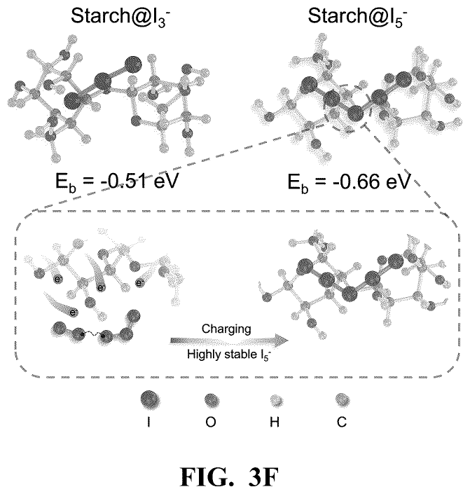

The colloidal Tyndall effect is a phenomenon observed when light is scattered by particles in a colloidal solution or a fine suspension. When a beam of light passes through such a solution, the light gets dispersed by the particles present in the solution, making the path of the light visible. This scattering of light is known as the Tyndall effect. As displayed in FIG. 3A(i), the colloidal Tyndall-effect could be observed in 1 M starch solution (M is molarity as mol L⁻¹), indicating the nanosized colloidal starch ranging within 1-100 nm, benefiting to form the colloidal aggregation. Compared to bare Iₓ⁻ solution (0.01M) without colloidal Tyndall-effect in FIG. 3A(ii), it could be still featured with the Tyndall-effect as Iₓ⁻ and starch mixed-solution (0.01M Iₓ⁻ solution and 1 M starch solution) in FIG. 3A(iii). This result could indirectly demonstrate that the amylose-type starch could capture the polyiodide anions Iₓ⁻ through strong bonding interactions, forming the starch/polyiodide colloidal complex.

To determine the suitable concentration of the starch-iodine electrolyte, the viscosity, ionic conductivity and the permeability of the starch-regulated electrolytes were investigated as the important parameters to determine the overall performance of the full flow battery, such as voltage efficiency (VE) and coulombic efficiency (CE).

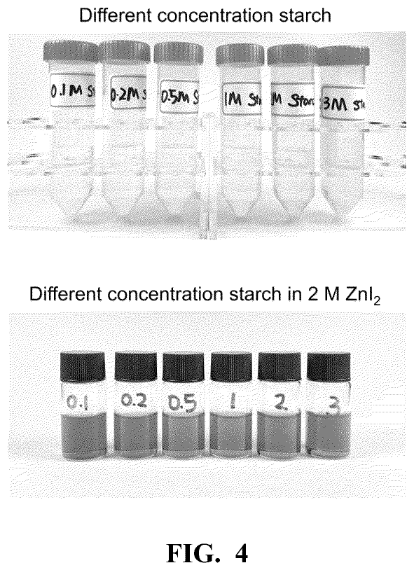

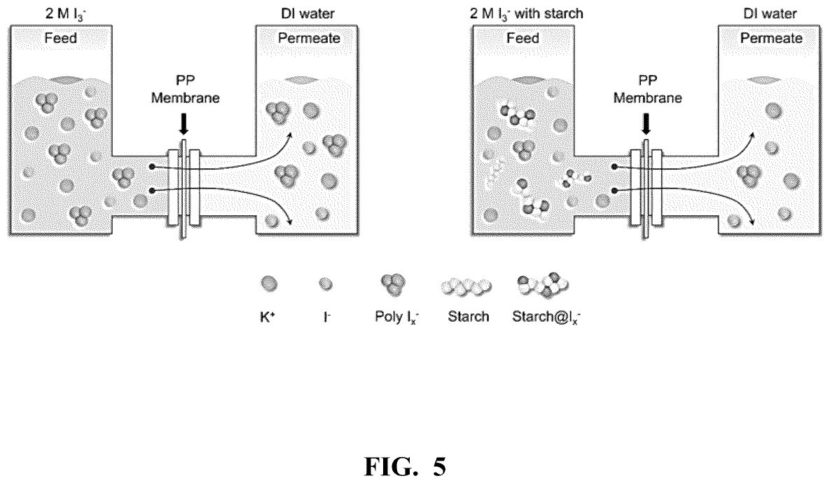

As shown in FIG. 3B and FIG. 4, the viscosity increased exponentially with increasing starch concentration (from 0 M to 3 M), where the concentration of the ZnI₂ was fixed at 2 M and the M is molarity as mol L⁻¹. Specifically, the viscosity value of 1 M starch-containing solution is 13.5 kPa·s, which dramatically increased to 227 kPa·s of 2 M starch-containing electrolytes, i.e., 20 times larger than that of the 1 M starch, and it was over 100 times higher of 3 M starch electrolyte (1570 kPa·s). In addition, the ionic conductivity gradually decreases from 100.1 mS cm⁻¹ to 6.5 mS cm⁻¹ when the starch concentration increases from 0 M to 3M. Generally, higher electrolyte viscosity would correspond to lower ionic conductivity, which indicated that the viscosity is the dominating factor in the ionic conductivity and 1 M starch in electrolytes can retain superior ionic conductivity. On the other hand, two-compartment H-cells consisting of the IS catholyte at 50% state of charge in one cell and deionized water in another cell were used to evaluate the permeability of IS colloids across the PP membrane, as schemed in FIG. 5.

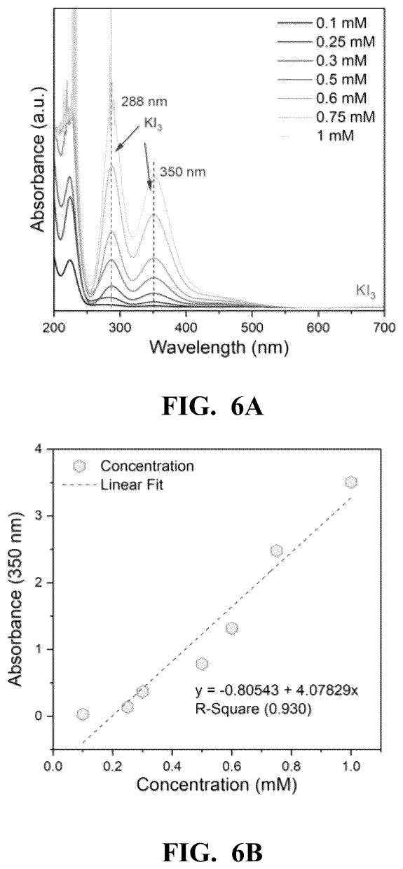

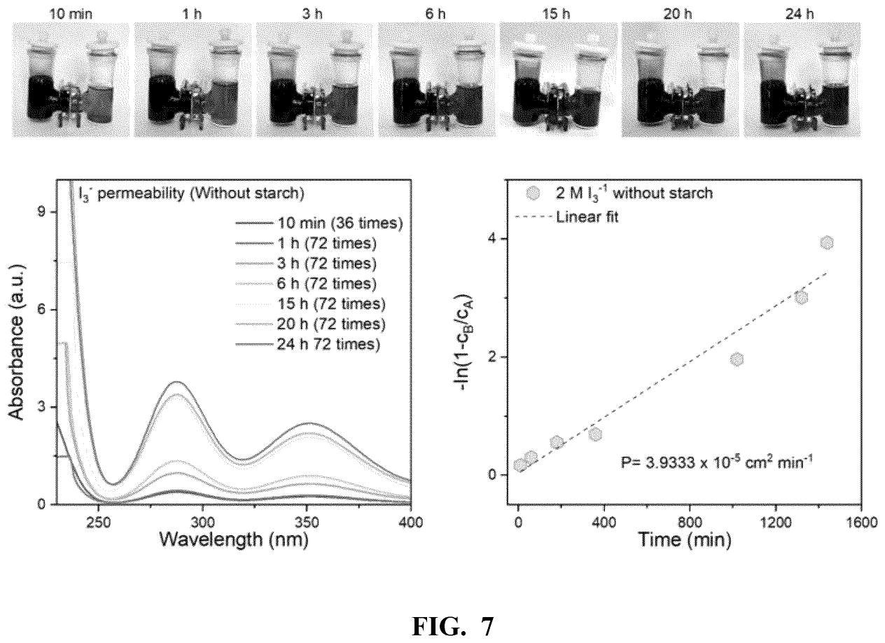

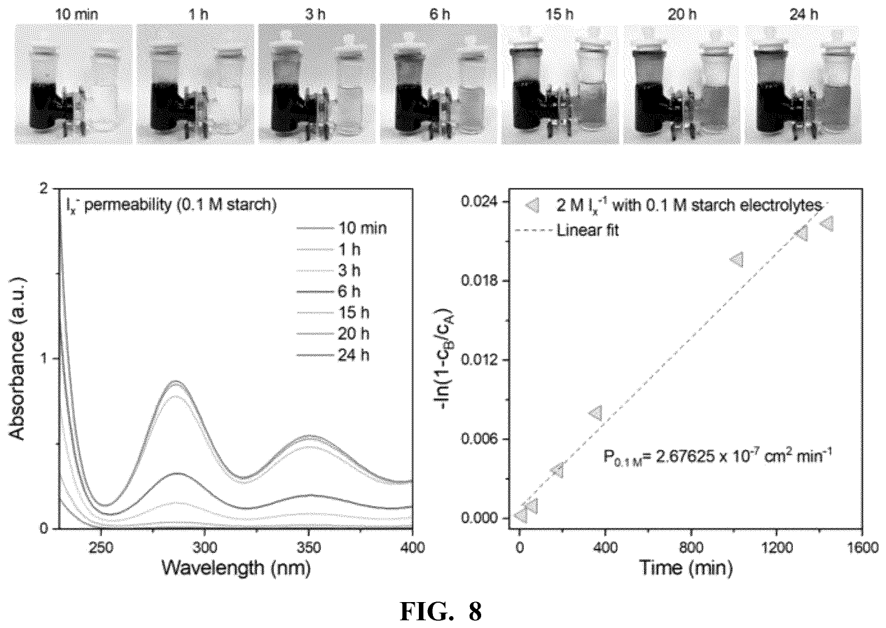

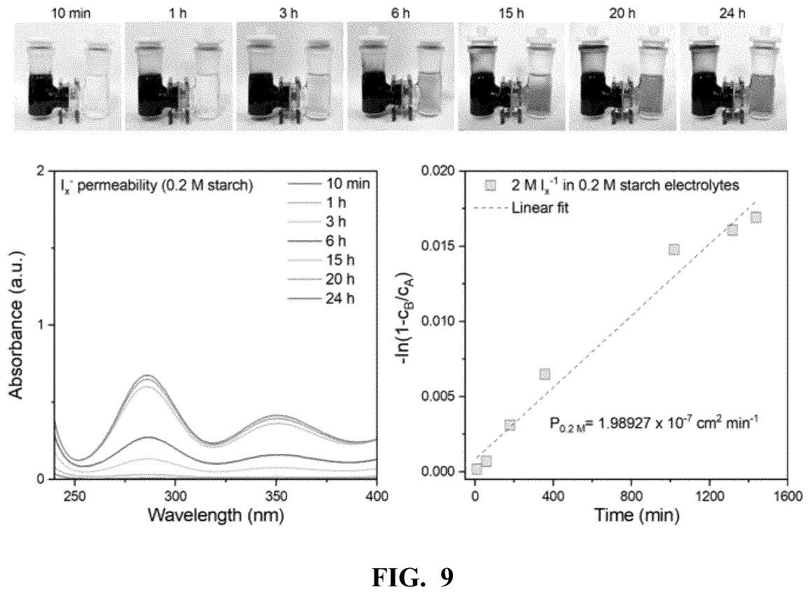

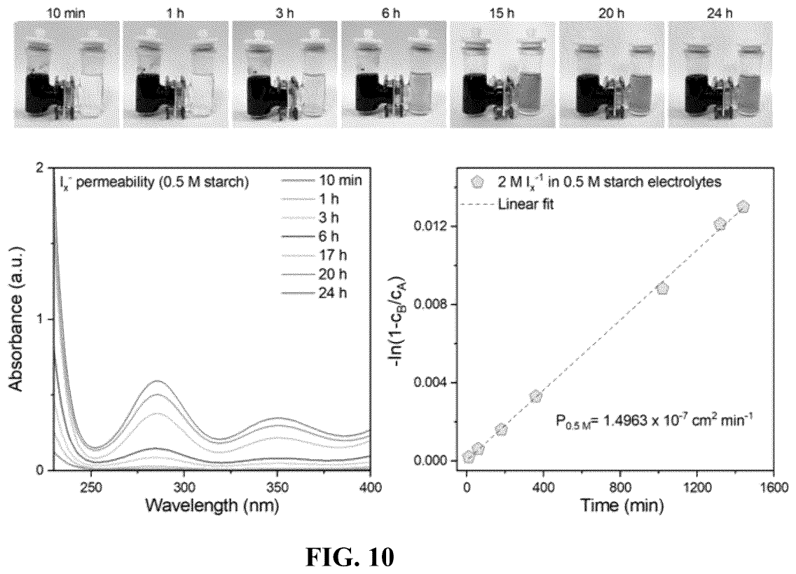

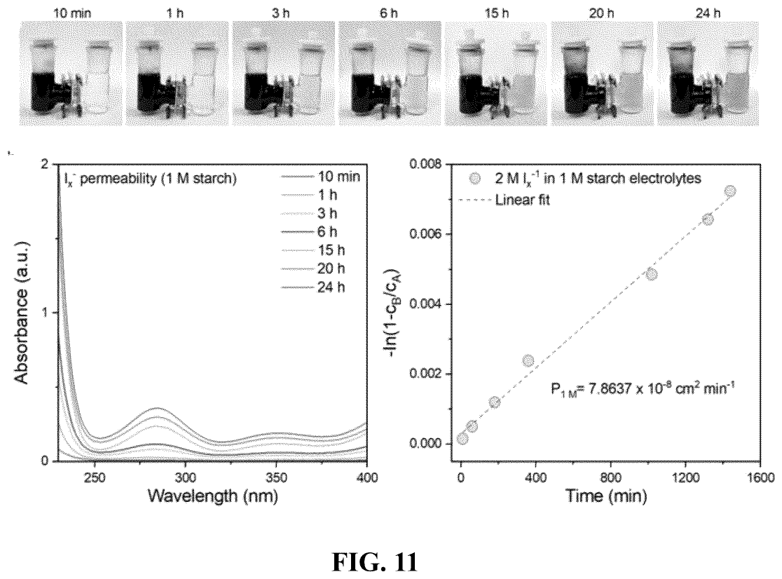

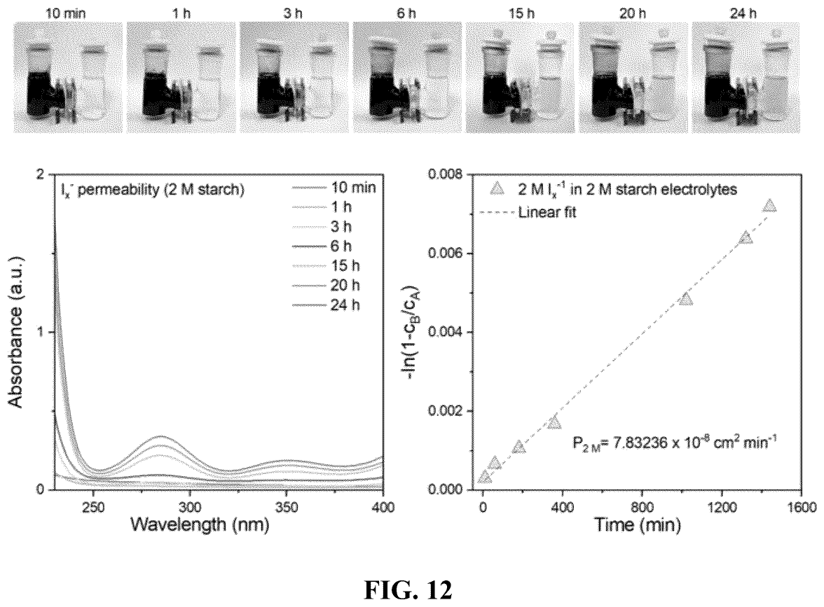

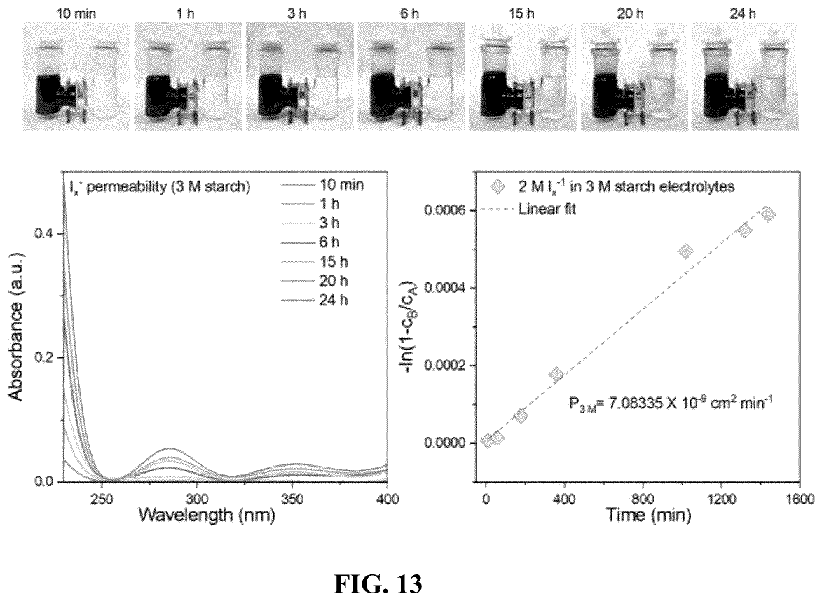

Referring to FIGS. 6A and 6B, UV-visible spectra of KI₃ under multiple concentrations between 0.1 mM to 1 mM had been tested. The strong peaks with the absorption wavelength of 288 and 350 nm are attributed to the presence of I₃⁻. The permeation rates of nominally prepared Iₓ⁻ solutions under different starch concentrations were shown in FIGS. 7-13. The y-axis represents −ln(1−c_{B}/c_{A}), and the x-axis represents permeation time. These parameters were used to determine the permeability of KI₃ through PP membranes under blank 2 M KI₃ and/or 2 M KI₃ with/without different concentrations of starch. The plots were fitted using linear fitting to obtain the best fits for −ln(1−c_{B}/c_{A}) against time (t).

In more detail, the permeability of KI₃ through PP membranes was determined from the evolution of the UV-visible spectra of the permeate side in H-cell tests). The feed reservoir was filled with 2 M KI₃, while the permeate side was filled with deionized water. The two reservoirs had a circularly symmetrical transport channel separated by PP membrane. It was assumed that the change of KI₃ concentration in the feed solution reservoir was negligible when their concentration in the permeation side was low and the flux of KI₃ through the membrane is a constant; that is, a pseudo-steady-state condition prevails in the two reservoirs during experiments.

$${V}_{B} \frac{d {c}_{B} ( t )}{dt} = \frac{AP}{L} [ {C}_{A} - {C}_{B} ( t ) ] , \qquad ( 1 )$$

$$ln ( 1 - \frac{{C}_{B} ( t )}{{C}_{A}} ) = - \frac{AP}{{LV}_{B}} [ t - {t}_{0} ] , \qquad ( 2 )$$

where c_{A} and c_{B} (t) were the concentrations (mol L⁻¹) of KI₃ in the feed and permeate side, respectively; A and L were the area (cm²) and thickness (cm) of the membrane, respectively; V was the volume of the permeate solution (ml); P was the membrane permeability (cm² min⁻¹); t was the time (min), and t₀ was the time lag (min). The permeability P could be determined from the slop of the plot of −ln(1−c_{B}(t)/c_{A}) versus t.

Compared to the severe permeability in blank electrolytes, the permeability of Iₓ⁻ largely decreased with the increased starch concentration. It indicated that the colloidal starch could strongly confine the iodine by forming a colloidal aggregation, featuring low iodine permeability to impede the cross-over issue. Taken together these analysis, 1 M starch and 2 M ZnI₂-based IS electrolytes were selected as the prototypical electrolyte for the following investigation.

### Example 4—Effect of Colloidal Aggregation on Particle Size

To investigate the colloidal aggregation effect of the IS electrolytes, their microscopic patterns and sizes were examined using atomic force microscope (AFM).

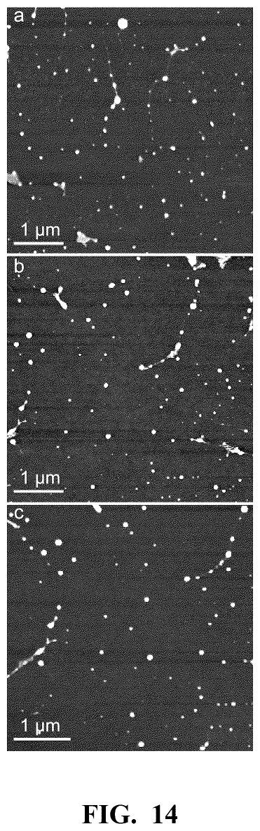

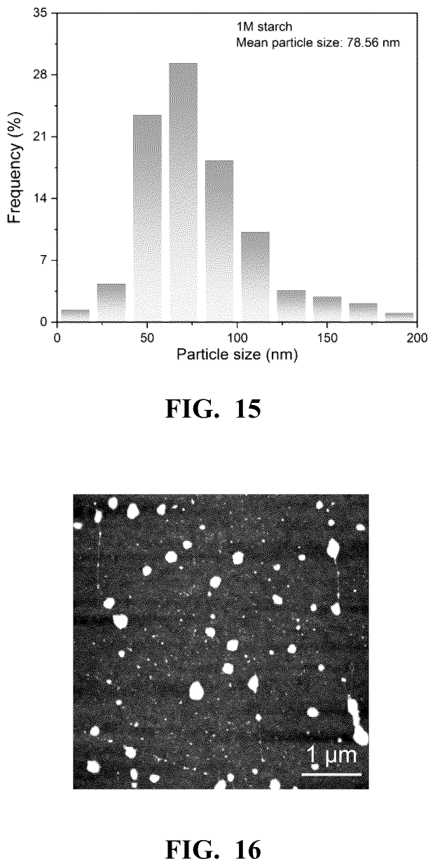

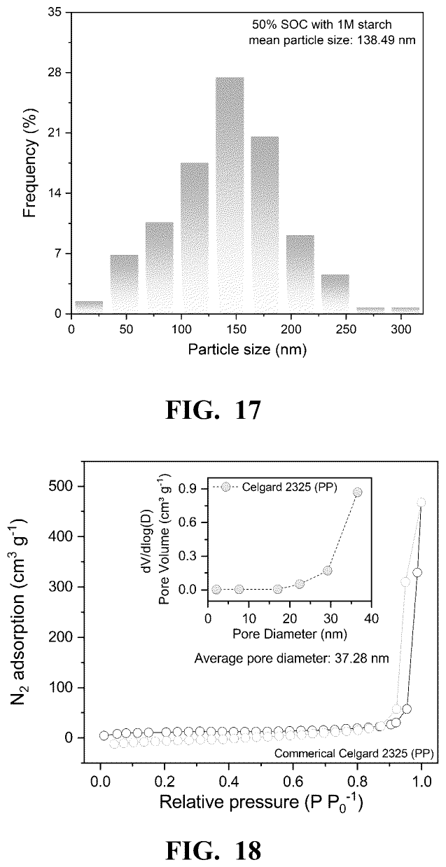

FIG. 3C and FIGS. 14-15 showed uniform nanoparticles of the bare starch colloid on the substrate, with a distinguishable nano-size of approximately 78.56 nm. In contrast, FIG. 3C and FIG. 16-17 showed that the mean size of the starch/polyiodides colloids in 50% state of charge was 138.49 nm, which was larger than the pristine bare starch. This phenomenon could be attributed to the strong chemisorption, promoting the aggregation between colloidal starch molecules containing abundant electron-rich hydroxyl groups and polyiodides Iₓ⁻.

Following the size-sieving rule, it effectively inhibited the permeability of IS colloids across PP membranes with nanosized pore diameters (FIG. 18, the average pore diameter was 37.28 nm), reasonably verifying that starch-containing colloidal electrolytes were beneficial for limiting the cross-over of active materials (polyiodides Iₓ⁻) in the catholyte.

### Example 5—Interaction Between Starch and Iodine

Referring to FIGS. 3D-3E, the starch/polyiodide complex solutions at different SOC (10%, 20%, 50%, 70%, 100%) were further confirmed by Raman spectra. The Raman peaks at 120 and 137.16 cm⁻¹ could be ascribed to the skeletal vibrations of metal-iodine ions (I⁻), while the two Raman peaks located at 110 and 160 cm⁻¹ could be ascribed to the triiodide ion (I₃⁻) and pentaiodide ion (I₅⁻), respectively. Regarding the electrolyte without starch, an intense I₃⁻ signal along with a weak I₅⁻ signal was shown in low 10% SOC and the I₅⁻ species signal gradually increased as high content of active redox in high charging SOC. Based on the no-starch system in FIGS. 3D-3E, the I₃⁻ peak exhibited barely shift but the Is peak became broaden with decreased intensity, which indicated the polyiodide complex was unstable especially at high concentrations.

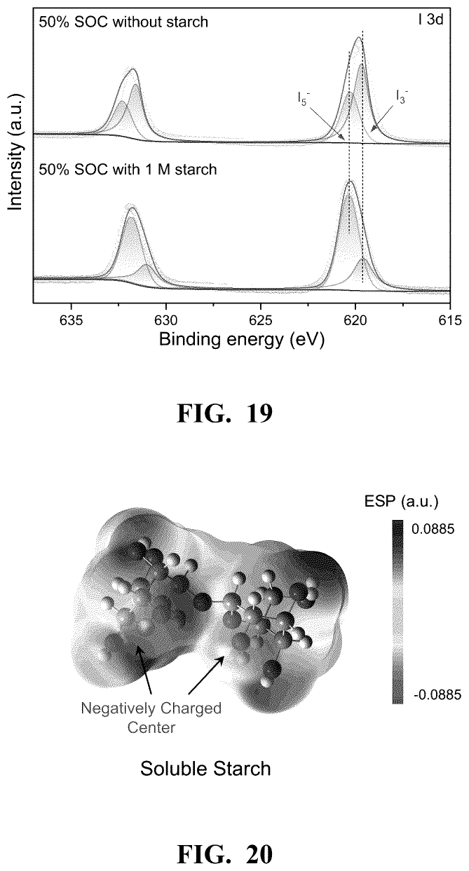

In contrast, both I₃⁻ and I₅⁻ species in starch-containing electrolytes presented stable peak signals and obvious blue-shifts by increasing the SOC large ratio from 0% to 100% SOC. It indicated the colloidal starch could stabilize the polyiodide active species, i.e., I₃⁻ and I₅⁻, based on the strong chemical bonding for colloidal chemistry. Moreover, the stable existence of I₅⁻ species on the colloidal starch could also be corroborated by I3d XPS profiles as displayed in FIG. 19, in which the I₅⁻ species presents a dominant role in starch-based electrolytes under 50% SOC compared with blank ZnI₂ electrolytes.

To understand in-depth the configurations of the IS species, density functional theory (DFT) calculations were conducted to investigate the bonding energy of starch with the dominant iodine species as I₃⁻ and I₅⁻. Turning to FIG. 3F, long-chain polymer-typed starch units were featured with larger bonding energy with I₅⁻ polyiodide species (−0.66 eV) compared to I₃⁻ species (−0.51 eV), which indicates the amyloses-configuration could induce strong interaction between the starch and the iodine species, and the starch could consequently form more stable combination with the I₅⁻ active species.

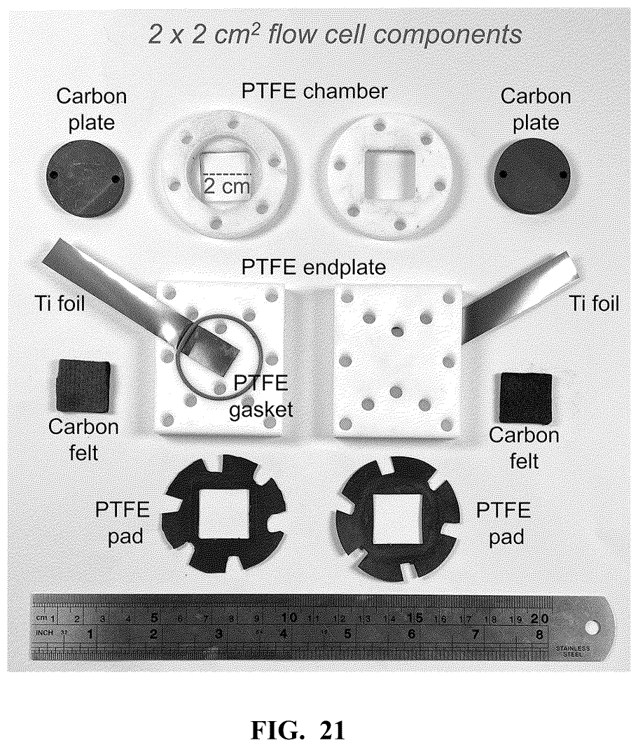

Turning to FIG. 20, the electrostatic potential (ESP)-mapping of starch molecules was shown. The positive and negative charge distributions revealed that the regions near the hydroxyl regions of starch have more negative ESP values, which were considered as strong electron-donating centers for chemical interactions. Meanwhile, as a Lewis acid, iodine atoms could react readily with electron-rich molecules via a charge transfer mechanism to form strong chemisorption complexes. Therefore, the hydroxyl-networks could form stabilized IS colloids by the strong chemisorption, verifying the colloidal chemistry with an aggregation effect.

### Example 6—Electrochemical Performance Analysis of Zinc-Iodine-Starch Flow Batteries (Zn—IS FBs)

The configuration of the Zn—I FBs cell assembly was as follows. Polytetrafluoroethylene (PTFE) frames were served as the flow channel to fix the position of the pretreated three-dimensional electrodes with a geometric area of 4.0 cm² (2×2 cm²) or 25 cm² (5×5 cm²) and a thickness of 2.0 mm. Carbon felt (CF) was utilized as both the positive and negative electrode. To make a flow-mode battery, a peristaltic pump (Chuang Rui Precision Pump) was employed to circulate the electrolyte flow through the electrodes.

The configuration of the Zn—IS FBs cell assembly was as follows. The iodine-starch (IS) colloids obtained from Example 3 were used as the catholyte for Zn—I flow battery system. The system contain a cathode side, an anode side, and a separator, which allow for the reversible electrochemical reactions to take place during charge and discharge cycles. The cathode side has an electrode material and a first storage tank providing a catholyte. The catholyte was composed of 2 M ZnI₂ dissolved in deionized water, while the anolyte was prepared with 2 M ZnCl₂ in deionized water. The presence of zinc iodide ensures a high charge capacity and stability, while the soluble starch acts as a stabilizing agent and facilitates the formation of aggregated colloidal nanoparticles in the electrolyte. On the anode side, an electrode material and a second storage tank provide an anolyte. The exact composition of the anolyte may vary based on the specific application and requirements of the flow battery system. Positioned between the cathode and anode, the separator acts as a physical barrier to prevent direct contact between the catholyte and anolyte. The separator must possess suitable ion-conductive properties to allow for the migration of ions between the two sides during the charge and discharge processes. Additionally, the separator should exhibit good chemical and mechanical stability to ensure prolonged battery life and consistent performance over multiple cycles.

To facilitate the continuous flow of anolyte and catholyte between the cathode and anode sides, a peristaltic pump can be utilized. This pump employs a cyclical compression and relaxation mechanism, which causes the flow of the electrolyte solutions through the flow battery system. The peristaltic pump ensures a controlled and consistent flow rate, contributing to the battery's reliable operation and energy output.

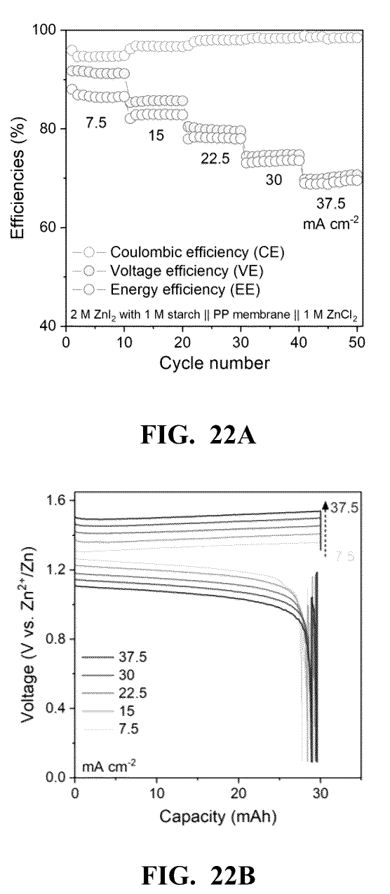

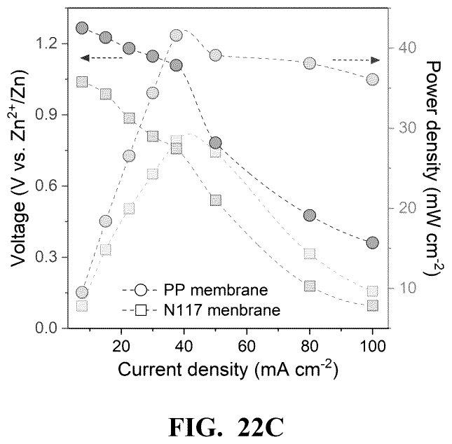

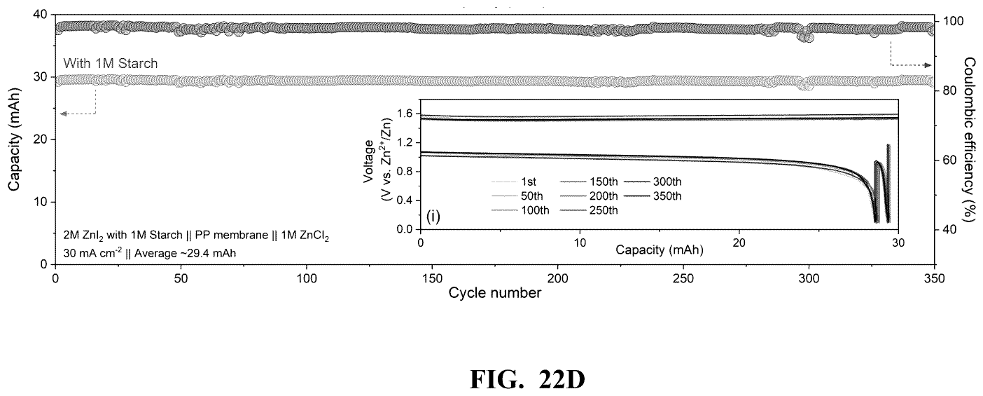

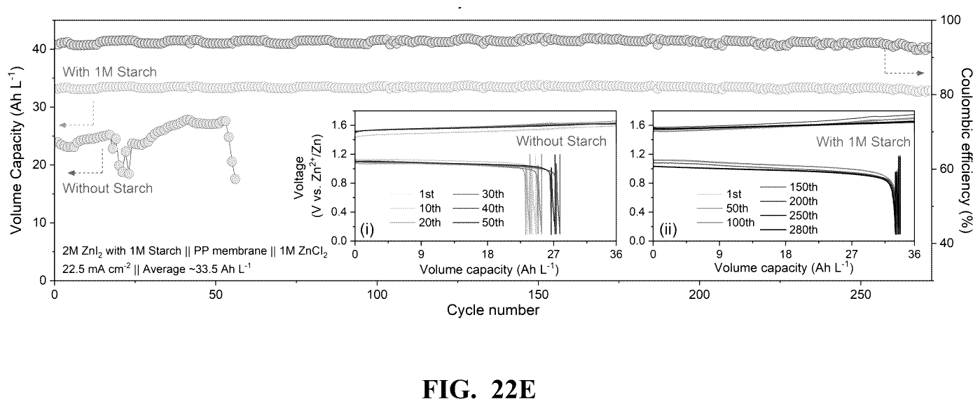

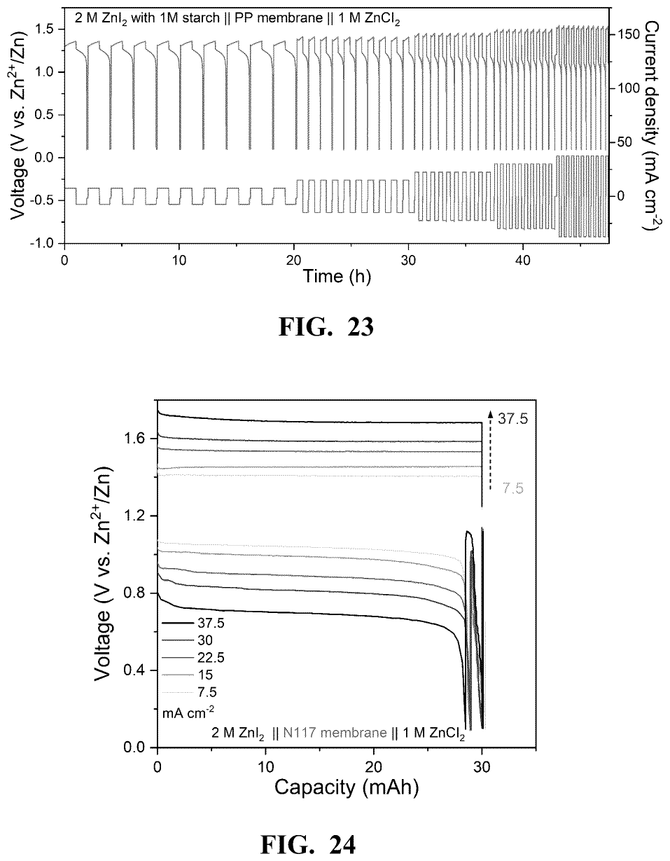

The aggregated colloidal nanoparticles present in the catholyte contribute to a more uniform and efficient electrochemical reaction during discharge and charge cycles. These nanoparticles prevent dendrite formation and aid in maintaining a stable electrode-electrolyte interface, thereby improving the overall cycle life of the flow battery system. The electrochemical performance data was collected to evaluate the impact of colloidal electrolytes on enhancing the cycling performance of Zn—I2 flow batteries based on 2×2 cm² flow cells (FIG. 21). As shown in FIG. 22A and FIG. 23, the results showed that the flow-mode Zn—IS FBs using the PP membrane (2 ml of 2 M ZnI₂ with 1 M starch∥8 ml of 2 M ZnCl₂ at 30 mAh) exhibited superior rate cycling and performance. At 7.5, 15, 22.5, 30 and 37.5 mA cm⁻², these batteries exhibited high coulombic efficiency (CE), voltage efficiency (VE) and energy efficiency (EE), as shown in Table 1.

TABLE 1
Coulombic efficiency (CE), voltage efficiency (VE) and energy
efficiency (EE) of Zn—IS FBs at different densities

| | Coulombic | voltage | energy |
|---|---|---|---|
| Current density | efficiency | efficiency | efficiency |
| (mA cm⁻²) | (CE)(%) | (VE)(%) | (EE)(%) |
| 7.5 | 94 | 91 | 86 |
| 15 | 96 | 85 | 83 |
| 22.5 | 98 | 81 | 78 |
| 30 | 98.5 | 75 | 74 |
| 37.5 | 98.6 | 70 | 70 |

Specifically, the CE of Zn—IS FBs gradually improved with an increase in current density, remaining consistently high at over 98%. This indicated the limited permeability of polyiodide active materials in the Zn—IS FBs during fast charging. Furthermore, the corresponding voltage profiles of Zn—IS FBs using the PP membrane were shown in FIG. 22B, revealing relatively low voltage polarization. This is attributed to the high ionic conductivity of the porous PP membrane and the starch-based colloidal electrolytes used in the Zn—IS FBs.

On the contrary, as depicted in FIG. 24, Zn—I FBs without starch integration, using the conventional Nafion membrane (N117), displayed superior selectivity of Iₓ⁻ active materials. However, the N117-based FBs system exhibited inferior rate capability and larger polarizations due to the low ionic conductivity and significant internal resistance of the membrane. The PP membrane-based Zn—IS FBs of the present invention could deliver a high-power density of 41.58 mW cm⁻², demonstrating higher power compared to N117 membrane-based Zn—I FBs with a relatively low power density of 28.41 mW cm⁻² (FIG. 22C).

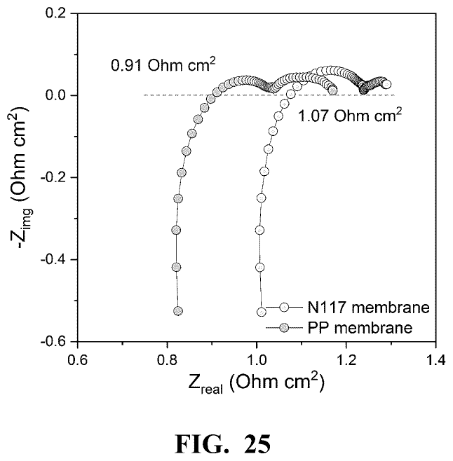

In addition, the as obtained Zn—I FBs based on porous PP membrane had a lower overall internal resistance of the full cell (0.91 Ωcm²) compared to that of N117-based FBs as 1.07 Ωcm² based on electrochemical impedance spectroscopy (EIS) result of FIG. 25. Consequently, the utilization of colloidal catholyte with porous PP membranes resulted in superior performance of Zn—I FBs compared to N117-based FBs.

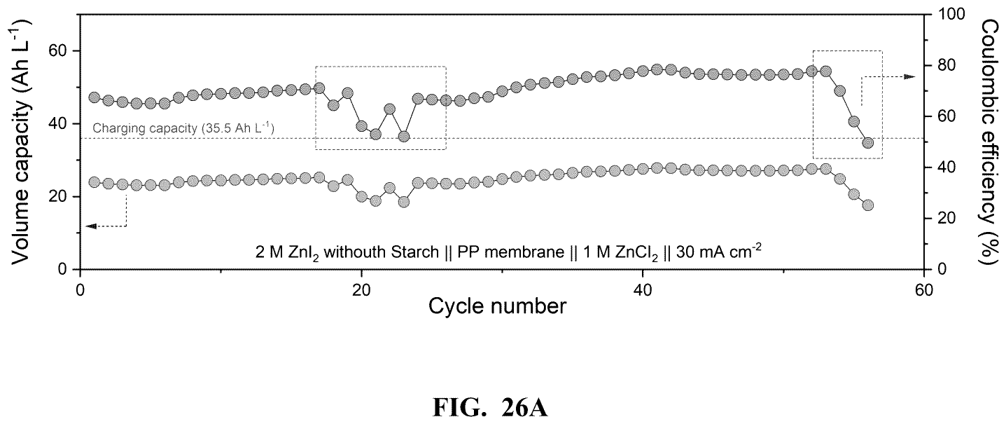

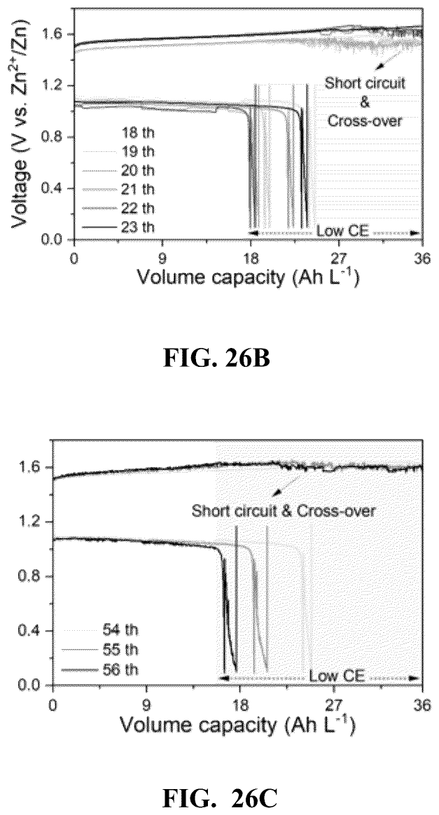

The cycling performance of the Zn—IS FB at high current density and high-volumetric capacity was evaluated. Referring to FIG. 22D, The Zn—IS FBs demonstrated stable charge-discharge operation over 350 cycles at a high current density of 30 mA cm⁻², achieving a high coulombic efficiency (CE) of 98.5%. Notably, this performance allowed for the realization of a volumetric capacity of 6 Ah L⁻¹_{catholyte}. Meanwhile, under a high volumetric capacity (33.5 Ah L⁻¹_{catholyte}) to realize the 50% utilization of the iodine, i.e., 50% SOC, the Zn—IS FBs flow system of the present invention could demonstrate long cycling calendar life (over 250 cycles) with and high CE (˜95%) at 22.5 mA cm⁻² (FIG. 22E), indicating the effective inhibition on the cross-over issue of iodine species. Under the same working condition, the PP membrane-based flow batteries in blank electrolytes without starch shown inferior CE at around 65% with serious capacity loss, lower the discharging capacity as ˜25 Ah L⁻¹_{catholyte}, and short cycle lifespan (˜50 cycles) due to the serious cross-over and short-circuits (FIGS. 26A-26C).

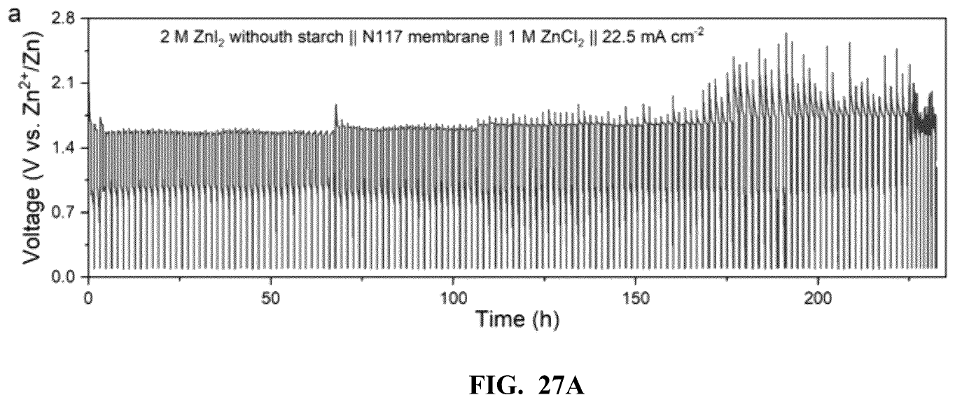

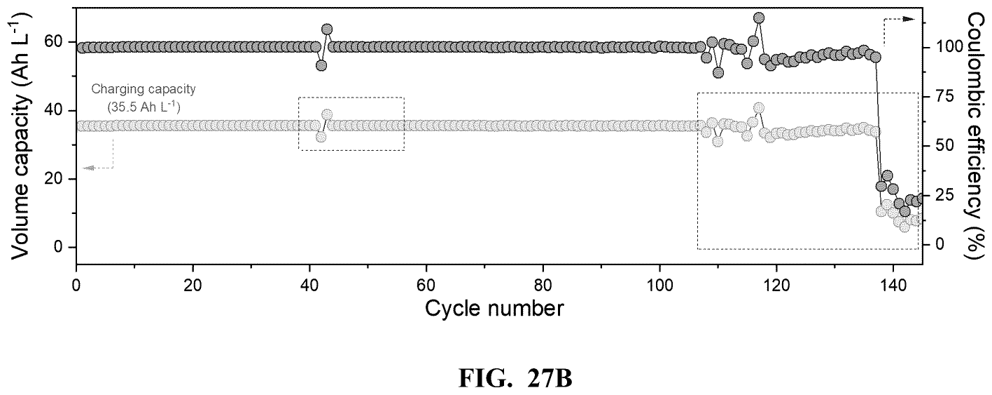

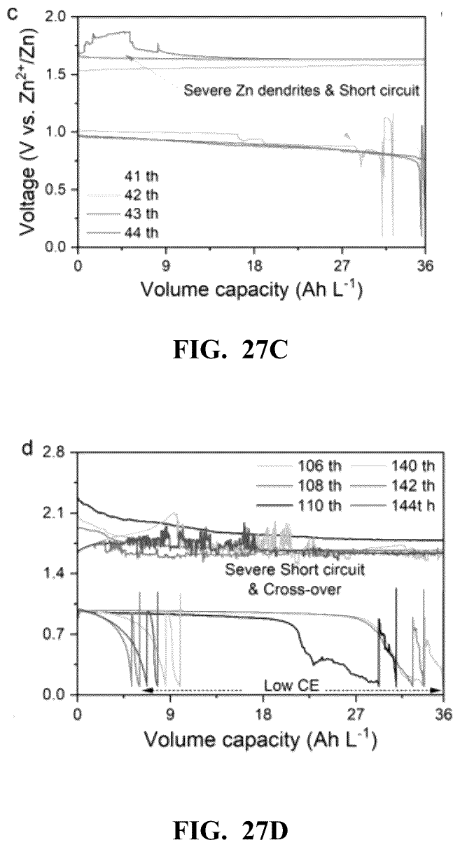

Referring to FIGS. 27A-D, the results showed that N117-based Zn—I FBs failed within a short period of 150 hours under high current density conditions. This failure was attributed to the formation of notable by-products resulting from severe side-reactions, leading to enlarged overpotential and short-circuits caused by Zn dendrites, causing performance fluctuations after just 42 cycles. The side reactions during battery cycling were identified as another critical issue that significantly impacts battery stability.

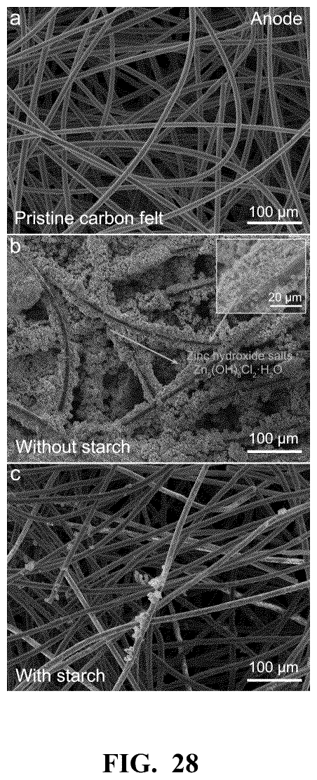

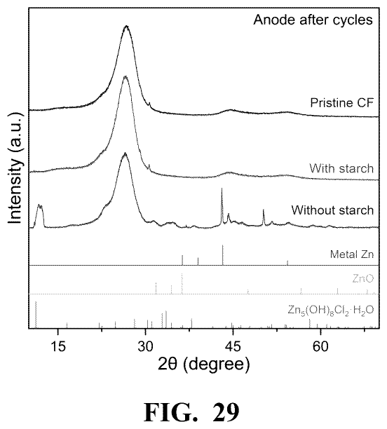

As shown in FIG. 28, SEM images of carbon felt (CF) at the Zn anode side during the discharge state exhibited an irregular and mossy morphology with a rugged surface. This phenomenon could be ascribed to the hydrogen evolution reactions that increased the pH of ZnCl₂ anolytes and produced by-products such as Zn₅(OH)₈Cl₂·H₂O and ZnO, as verified by the XRD results (FIG. 29). In contrast, a smooth and clean surface was observed on the anode collector after the same cycling. This observation could be attributed to the ultrasmall-sized colloidal starch that crossed the membrane to the anolyte and consequently stabilized the pH of the anolyte, hence endowing an improved reversibility of the Zn anode.

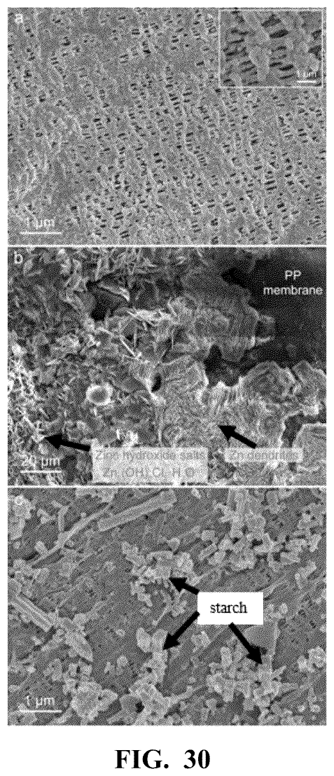

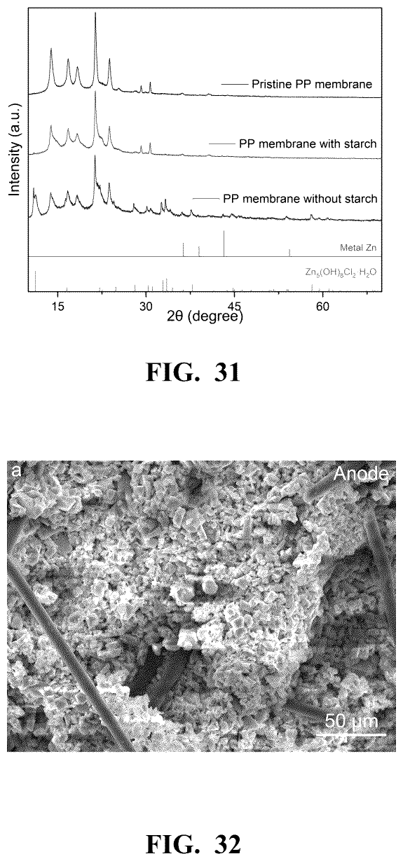

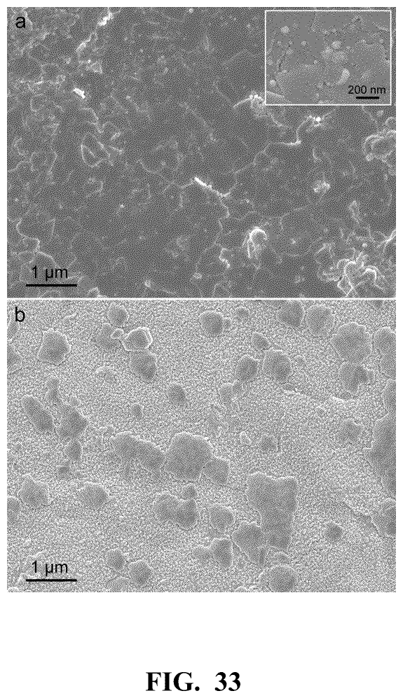

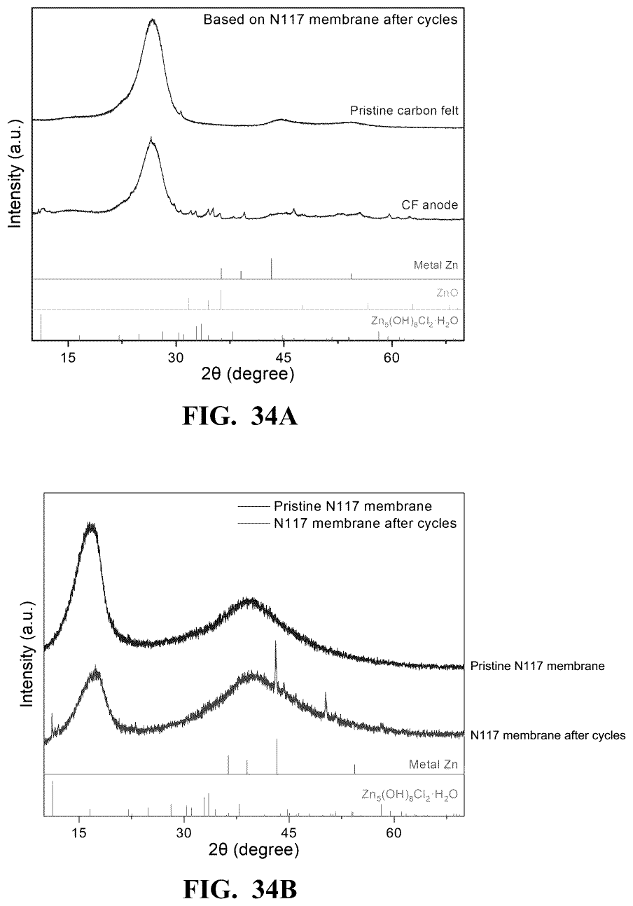

Referring to FIGS. 30-31, after cycles in starch-based colloidal electrolytes, SEM images and XRD patterns of the PP membrane revealed a cleaner surface compared to the membrane after cycles in blank electrolytes. Moreover, N117-based Zn—I FBs in blank electrolytes also showed severe side reactions at Zn anode side with dead dendrites and significant by-products (FIGS. 32-34). As a result, the utilization of starch-based colloidal chemistry not only enabled higher working currents and higher energy for the iodine cathode side but also enhanced cycling stability for the Zn anode side, leading to improved overall performance for the Zn—IS FBs systems.

### Example 7—Preparation of Renewable Solar-Energy Storage System

In order to showcase the potential application of starch-based colloidal electrolytes for outdoor flow battery systems, the electrochemical performance of Zn—IS FBs was characterized under elevated temperatures, with both the reservoirs and cells maintained at 50° C.

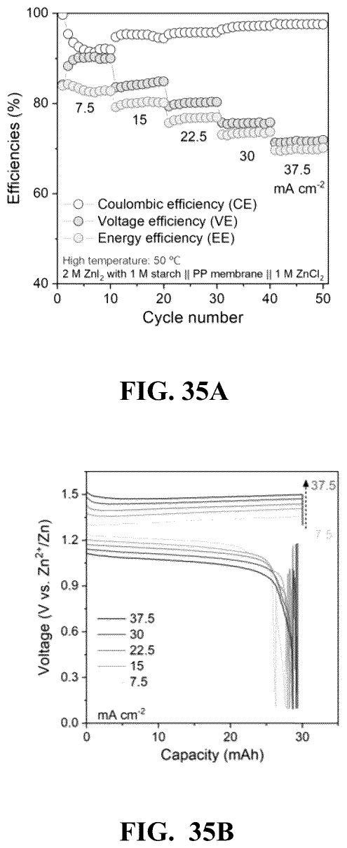

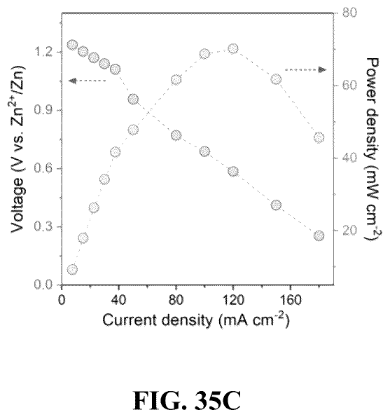

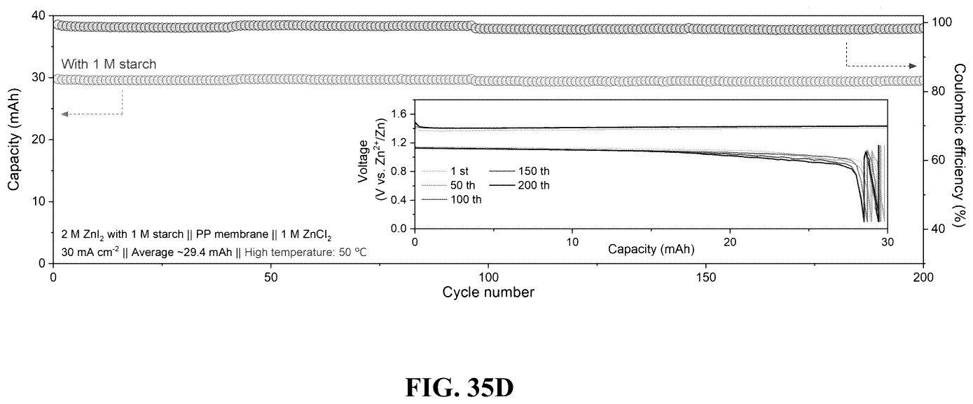

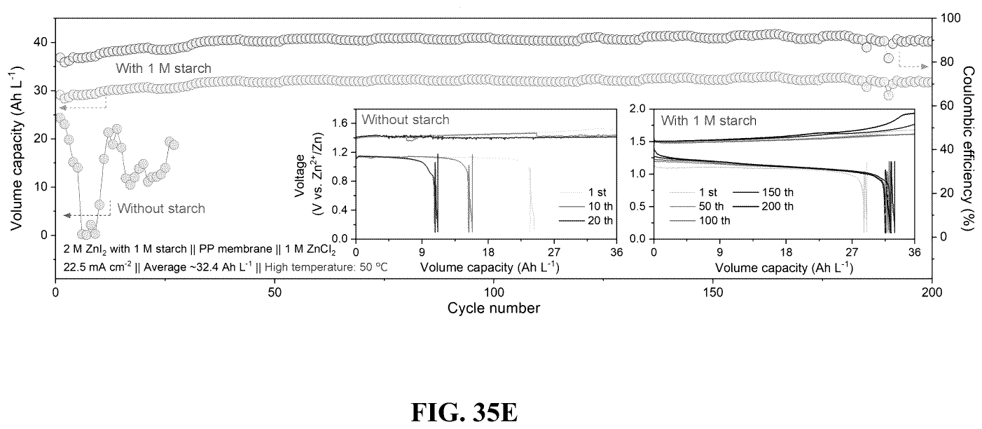

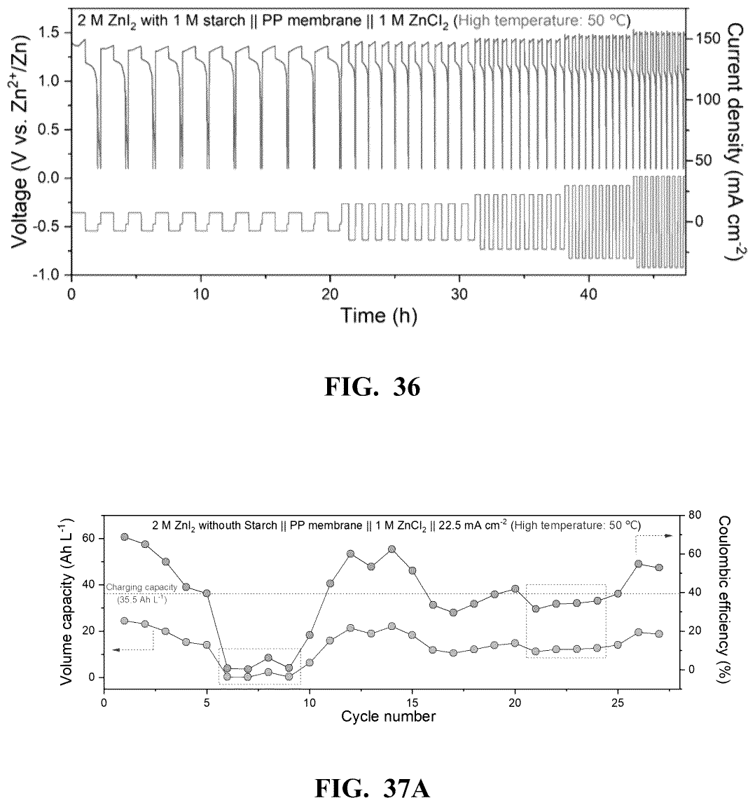

As shown in FIGS. 35A-35B and FIG. 36, the Zn—IS FBs using the PP membrane (2 ml of 2 M ZnI₂ with 1 M starch∥8 ml of 2 M ZnCl₂ at 30 mAh) at high temperatures (50° C.) exhibited a wide range of stable cycling power capability with high CE, VE, and EE, as shown in Table 2.

TABLE 2
Coulombic efficiency (CE), voltage efficiency (VE)
and energy efficiency (EE) of Zn—IS FBs at different
densities under high temperature at 50° C.

| | Coulombic | voltage | energy |
|---|---|---|---|
| Current density | efficiency | efficiency | efficiency |
| (mA cm⁻²) | (CE)(%) | (VE)(%) | (EE)(%) |
| 7.5 | 92 | 90 | 84 |
| 15 | 95 | 84 | 81 |
| 22.5 | 96 | 80 | 77 |
| 30 | 97 | 75 | 74 |
| 37.5 | 98 | 71 | 70 |

Moreover, the Zn—IS FBs still delivered a high-power of 70.12 mW cm⁻² due to the smaller polarization with the high ionic conductivity at high temperatures (FIG. 35C). The Zn—IS FBs could accommodate a stable cycling operation over 200 cycles with high CE as 98.9% at a high current density of 30 mA cm⁻² charging mode under high temperature at 50° C. (FIG. 35D). Furthermore, when operated at a high volume capacity of 35.5 Ah L⁻¹, the Zn—IS FBs based on colloidal chemistry exhibited superior cycling stability for 200 cycles with a considerable CE (˜91%) and discharging capacity of 32.4 Ah L⁻¹ at 50° C.

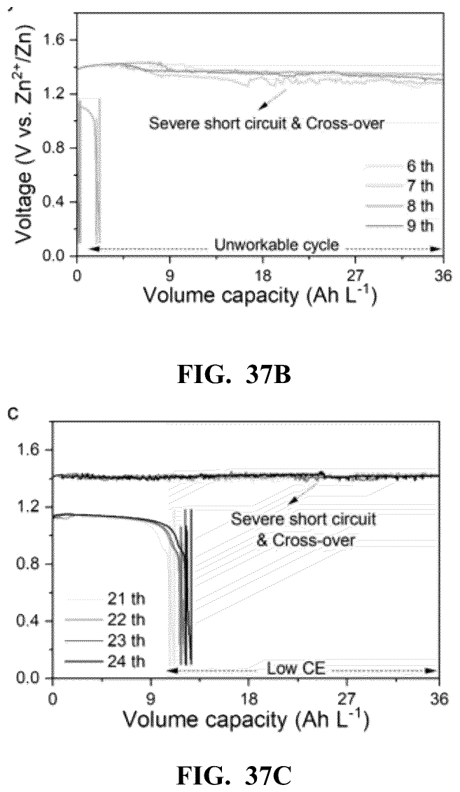

The cycling and charging/discharging profiles of the Zn—I FBs without starch colloids in catholyte were shown in FIGS. 37A-37C. In stark contrast, it exhibited unstable cycling with fluctuating and low CE (below 40%), a low volumetric capacity (˜18 Ah L⁻¹_{catholyte}) at the same charged capacity and temperature. The Zn—IS FBs based on colloidal catholytes revealed notably higher CE and superior cycling stability. Such superior performance could be attributed to the effective suppressions of the cross-over issue by the IS colloids through the size-sieving effect at the cathode side and the mitigation of hydrogen evolution and Zn dendrite issues at the anode side.

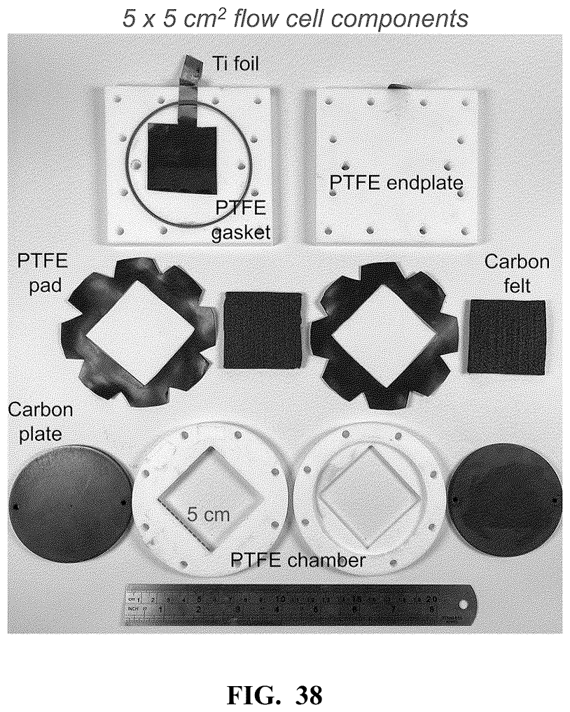

Referring to FIG. 38, PTFE was used as the endplate and it was fixed with screws. Then, the PTFE frame was install as a flow channel. Next, the carbon felt was placed into a PTFE chamber. After that, the membrane was installed, and the PTFE frame, carbon felt, PTFE endplate were sequentially assembled, finally securing them with nuts. Subsequently, the battery system was connected to a peristaltic pump, and all interfaces were joined using PTFE connectors. The superior performance of the Zn—IS FBs enabled further investigation into its potential for storing renewable energy from solar sources. The scale-up Zn—IS FBs with an enlarged membrane area (25 cm² cell sizes, FIG. 38) were successfully integrated with solar photovoltaic panels.

In this example, the Zn—I FBs cell pack (25 cm², 5.0×5.0 cm²) was integrated into a wind and photovoltaic power generating system. During the operation of the Zn—I FBs, no battery management system was used to control each individual Zn—I FBs to demonstrate the working flexibility of the Zn—I FBs under fluctuating charge voltage. The output of the photovoltaic power cell was connected to input of the ultralow power DC-DC boost converter bq25504 EVM with constant voltage of 2 V and the Zn—I FBs cell pack was connected toed to the output of the converter for charging. The solar light intensity was collected and measured by the sunlight detection Sanliang-PP730. The output current was collected by CHI measurement.

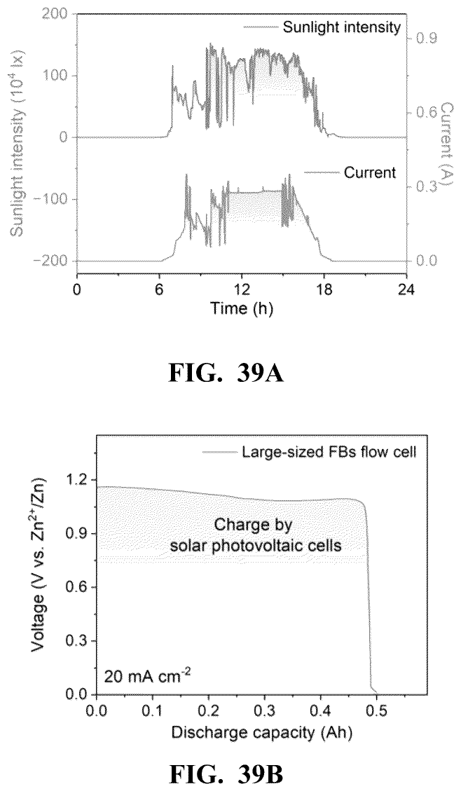

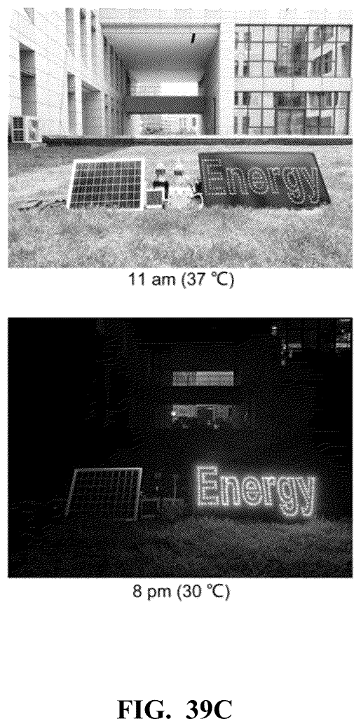

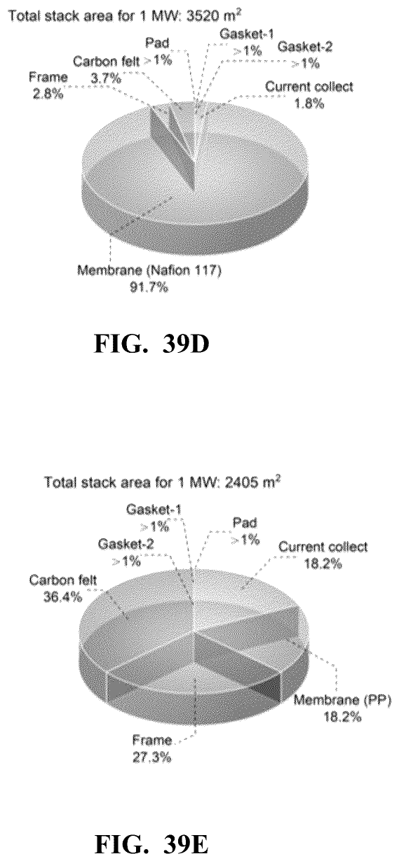

The data of solar intensity and corresponding solar-to-current conversion was detected through a controller for 1 day. As displayed in FIG. 39A, the output currents of the solar cell stack, i.e., the charging currents for the Zn—IS FBs, began to rise after sunrise at 6:00 am. It approached 0.3 A and remained from approximately 12:00 to 15:00 pm and decreased after the sunset (18:30 pm). The fluctuations in the charging current could be attributed to the instability and the intermittency of the solar intensity. Overall, the energy conversion process was finished by converting the sun energy into electrochemical energy in the Zn—IS FBs. Then, the Zn—IS FBs were switched to the discharging mode, which could deliver the capacity as 0.496 Ah and the energy as 0.535 Wh at 20 mA cm⁻², revealing the practical application of Zn—IS FBs as power supply (FIG. 39B).

Impressively, the Zn—IS FBs successfully powered the logo ‘Energy,’ composed of 280 green LED bulbs. It is worth noting that temperatures reached nearly 45.8° C. during the noonday sun at 2:00 pm (data recorded in South China). The successful integration of the scale-up Zn—IS FBs battery module with the photovoltaic cell panel demonstrated their high adaptability as large-scale energy storage systems in future smart grids.

### Example 8—Cost Analysis

The installed cost of the flow cell was one of the most critical factors that determined the commercialization potential for the demonstrated system. The present invention economically calculated the installed cost to construct a 1-MW zinc-iodine flow battery stack based on the Nafion 117 membrane and PP membrane with colloidal electrolytes, as shown in FIGS. 39D-39E. Based on the power performance of the Zn—I FBs, the typical N117-based FBs had a power density of 28.41 mW cm⁻², while the as-developed PP-based FBs exhibited a power density of 41.58 mW cm⁻² (FIG. 22C). As a result, the required stack membrane area for the simulated output 1-MW system was 3520 m² for the N117 membrane and 2405 m² for the PP membrane systems. The detailed cost and the amount of components for the 1-MW flow cell stack were provided in Table 3.

TABLE 3
The components and their costs for a 1 MW zinc-iodine flow battery stack

| | | Amount of N117 | | Amount of PP | |
|---|---|---|---|---|---|
| | Price per | membrane- | Total cost of | membrane- | Total cost of |
| | unit | based Zn—I FBs | N117-based | based Zn—I | N117-based |
| Component | ($ m²) | (m²) | Zn—I FBs ($) | FBs (m²) | Zn—I FBs ($) |
| Current | 10 | 3620 | 36200 | 2405 | 24050 |
| collector | | | | | |
| Membrane | PP: 10 | | 1810000 | | 24050 |
| | N117: 500 | | | | |
| Frame | 15 | | 54300 | | 36075 |
| Carbon felt | 20 | | 72400 | | 48100 |
| Gasket-1 | 1 | 4 pieces | 4 | 4 pieces | 4 |
| Gasket-2 | 2 | 4 pieces | 8 | 4 pieces | 8 |

| Total cost for 1 MW | 1.97291 million ($) | 0.13228 million ($) |
|---|---|---|
| Zn—I FBs | | |

Note:
According to the power density in FIG. 22C, the stack area of N117 membrane-based Zn—I FBs need about 3519.887 m² at 28.41 mW cm⁻² for working 1 MW Zn—I FBs, and the stack area of PP membrane-based Zn—IS FBs only need about 2404.598 m² at 41.587 mW cm⁻² for working 1 MW Zn—IS FBs. All component calculated from the the average of the future state estimation at 2014.

In Table 3, the Nafion membrane cost accounted for the highest proportion (91.7%, $500 per m²), which led to a high installed cost of the full cell, amounting to 1.97 million dollars for the 1-MW cell. In contrast, by replacing the Nafion 117 membrane with the PP membrane, the cost of the 1-MW flow stack dramatically decreased by 93.2% in the installed cost, resulting in 0.13 million dollars, i.e., 14.3 times lower in cost. Such a significant difference could be attributed to the membrane cost accounting for the lower proportion (18.2%, $10 per m²) for the Zn—IS FBs, indicating that the reduced membrane cost could significantly reduce the installed cost of the flow battery in practical applications. Therefore, it can be foreseen that further optimization of the colloidal chemistry-based flow battery components could advance a reinvigorated arena of next-generation zinc-based flow batteries with power cost-effectiveness and remarkable energy density for future grid-scale energy storage applications in hot climates.

In summary, the present invention introduces a novel colloidal chemistry featuring starch for enhanced polyiodide selectivity based on the size-sieving effect, enabling the use of low-cost porous PP membranes as LPPM with superior ion conductivity suitable for Zn—I FBs. This advancement facilitates high working currents, high-power operation, and stable cycling of Zn—IS FBs based on PP membranes. Consequently, the Zn—IS FBs with colloidal catholyte can sustain a high current density of 37.5 mA cm⁻², power density of 42 mW cm⁻², high coulombic efficiency of 98.5%, and stable cycling over 350 cycles.

Furthermore, the colloidal Zn—IS FBs systems developed in the present invention exhibit stable cycling over 250 cycles, even at a high volumetric capacity of 32.4 Ah L⁻¹ (50% SOC) under elevated temperature conditions (50° C.). This outcome is attributed to the effective size-sieving of the starch-iodine complex, facilitated by strong chemisorption. Additionally, the applied starch colloids improve the reversibility of the Zn anode and enhance the cycling stability of Zn—IS FBs.

Cost-simulated analysis, based on a 1-MW flow cell, reveals a dramatic reduction in the installed cost of PP membrane-based stacks, approximately 15 times lower compared to those based on Nafion membranes (i.e., 14.3 times lower in cost).

Moreover, the scaled-up flow battery module demonstrates potential integration with photovoltaic solar packs, creating integrated renewable energy storage systems. This invention serves as a model system to explore colloidal electrolyte chemistries for the development of LPPM-based flow batteries with low-cost, high-power, and high-temperature adaptability, making them suitable for large-scale energy storage applications.

### INDUSTRIAL APPLICABILITY

Large-scale energy storage is a vital technology for improving the utilization efficiency of clean and renewable energies, such as wind and solar energy. Among the various options, flow batteries with low-cost and high power are considered one of the most promising candidates for large-scale energy storage systems. Aqueous zinc-iodine flow batteries (Zn—I FBs) show great potential for such storage systems due to their low-cost, high safety, and high energy density. The present invention develops an iodine-starch (IS) catholyte system that achieves high ion selectivity and ionic conductivity, allowing it to seamlessly integrate with the porous membrane and exhibit excellent reversibility and superior performance in Zn—I FBs.

In addition, based on a cost-stimulation analysis for a 1-MW flow stack of Zn—I FBs, it was found that the Nafion membrane cost accounted for the highest proportion (91.7%, $500 per m²), resulting in a high installed cost of approximately 1.97 million dollars for the 1-MW cell. However, by replacing the Nafion 117 membrane with the PP membrane, the cost of the 1-MW flow stack dramatically decreased by 93.2% to 0.13 million dollars, which is approximately 14.3 times lower in cost. This significant difference can be attributed to the fact that the membrane cost accounts for a lower proportion (18.2%, $10 per m²) for IS-electrolyte-based Zn—I FB, indicating that utilizing this invention could substantially reduce the installed cost of the flow battery in practical applications.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

What is claimed is:

1. A rechargeable aqueous Zn∥IS flow battery system, comprising:
a cathode side comprising an electrode material and a first storage tank providing a catholyte, wherein the catholyte comprises zinc iodide (ZnI₂) and a soluble starch, forming an electrolyte having aggregated colloidal nanoparticles;
an anode side comprising the electrode material and a second storage tank providing an anolyte; and
a separator positioned between the cathode and anode,
wherein the anolyte and the catholyte flow between the cathode and the anode by a peristaltic pump,
when the rechargeable aqueous Zn∥IS flow battery system is in a charging state, the electrode material on the cathode side absorbs and stores one or more ions from the catholyte, and the electrode material on the anode side absorbs and stores one or more ions from the anolyte.

2. The rechargeable aqueous Zn∥IS flow battery system of claim 1, wherein the electrode material comprises carbon felt.

3. The rechargeable aqueous Zn∥IS flow battery system of claim 2, wherein the carbon felt has a geometric area of 4.0 cm² and a thickness in a range of 1-5 mm.

4. The rechargeable aqueous Zn∥IS flow battery system of claim 1, wherein the aggregated colloidal nanoparticles have a mean diameter in a range of 120-140 nm.

5. The rechargeable aqueous Zn∥IS flow battery system of claim 1, wherein the anolyte comprises zinc chloride.

6. The rechargeable aqueous Zn∥IS flow battery system of claim 1, wherein the catholyte is prepared with 2 M ZnI₂ and 0.1 to 2 M of soluble starch dissolved in deionized water, while the anolyte is prepared with 2 M ZnCl₂ in deionized water.

7. The rechargeable aqueous Zn∥IS flow battery system of claim 1, wherein the separator comprises a porous polypropylene membrane.

8. The rechargeable aqueous Zn∥IS flow battery system of claim 1, wherein the rechargeable aqueous Zn∥IS flow battery system further comprises a PTFE endplate, a PTFE chamber, a PTFE gasket, a PTFE pad, a PTFE tube, a carbon plate and a Ti foil.

9. The rechargeable aqueous Zn∥IS flow battery system of claim 1, wherein the rechargeable aqueous Zn∥IS flow battery system has an overall internal resistance of less than 1 Ωcm².

10. The rechargeable aqueous Zn∥IS flow battery system of claim 1, wherein the rechargeable aqueous Zn∥IS flow battery system has a power density of at least 40 mW cm⁻².

11. The rechargeable aqueous Zn∥IS flow battery system of claim 1, wherein the rechargeable aqueous Zn∥IS flow battery system exhibits at least 94% coulombic efficiency, at least 75% voltage efficiency, and at least 74% energy efficiency at current densities ranging from 7.5 to 30 mA cm⁻² at room temperature.

12. The rechargeable aqueous Zn∥IS flow battery system of claim 1, wherein the rechargeable aqueous Zn∥IS flow battery system exhibits at least 90% coulombic efficiency, at least 75% voltage efficiency, and at least 74% energy efficiency at current densities ranging from 7.5 to 30 mA cm⁻² at a high temperature of 50° C.

13. The rechargeable aqueous Zn∥IS flow battery system of claim 1, wherein the rechargeable aqueous Zn∥IS flow battery system delivers a performance in terms of cycling stability for 350 cycles at 30 mA cm⁻².

14. The rechargeable aqueous Zn∥IS flow battery system of claim 1, wherein the rechargeable aqueous Zn∥IS flow battery system delivers a performance in terms of cycling stability for 200 cycles at a high volumetric capacity of 32.4 Ah L⁻¹ at a high temperature of 50° C.

15. A wind and photovoltaic power generating system comprising the rechargeable aqueous Zn∥IS flow battery system of claim 1.
